(19) United States
(12) Patent Application Publication
(10) Pub. No.: US 2026/0025715 A1
(43) Pub. Date: Jan. 22, 2026

(54) CONTEXT TRANSFER IN WIRELESS NETWORKS

(71) Applicant: Samsung Electronics Co., Ltd., Suwon-si (KR)

(72) Inventors: Peshal Nayak, Plano, TX (US); Boon Loong Ng, Plano, TX (US); Rubayet Shafin, Allen, TX (US); Vishnu Vardhan Ratnam, Frisco, TX (US); Yue Qi, Plano, TX (US); Bilal Sadiq, Plano, TX (US)

(21) Appl. No.: 19/245,139

(22) Filed: Jun. 20, 2025

Related U.S. Application Data
(60) Provisional application No. 63/674,058, filed on Jul. 22, 2024.
(60) Provisional application No. 63/687,141, filed on Aug. 26, 2024.
(60) Provisional application No. 63/751,918, filed on Jan. 31, 2025.
(60) Provisional application No. 63/767,839, filed on Mar. 6, 2025.
(60) Provisional application No. 63/802,172, filed on May 8, 2025.

(51) Int. Cl. H04W 36/00; H04W 36/18

(52) U.S. Cl. CPC H04W 36/0016; H04W 36/0033; H04W 36/18

(57) ABSTRACT

A station (STA) may transmit an intent to roam to one or more neighboring APs to a current AP associated with the STA. In some embodiments, a context transfer may be performed to transfer contexts from a current AP to a target AP, where the context transfer may reduce a time that may be needed for a link to reach an optimal performance level upon the STA roaming to a target AP. A context transfer may include an exchange of relevant information between APs, including between a current AP and a target AP, such that the target AP is aware of one or more parameters of one or more contexts when the STA roams to the target AP.

### CROSS-REFERENCE TO RELATED APPLICATIONS

This application claims the benefit of priority from U.S. Provisional Application No. 63/674,058 entitled “CONTEXT TRANSFER INDICATION PROCEDURES FOR NEXT GENERATION WLANS” filed Jul. 22, 2024; U.S. Provisional Application No. 63/687,141, entitled “CONTEXT TRANSFER INDICATION PROCEDURES FOR NEXT GENERATION WLANS” filed Aug. 26, 2024; U.S. Provisional Application No. 63/751,918, entitled “CONTEXT TRANSFER INDICATION PROCEDURES FOR NEXT GENERATION WLANS” filed Jan. 31, 2025; and U.S. Provisional Application No. 63/767,839, entitled “CONTEXT TRANSFER INDICATION PROCEDURES FOR NEXT GENERATION WLANS” filed Mar. 6, 2025, and U.S. Provisional Application No. 63/802,172 entitled “CONTEXT TRANSFER INDICATION PROCEDURES FOR NEXT GENERATION WLANS” filed May 8, 2025, all of which are incorporated herein by reference in their entireties.

### TECHNICAL FIELD

This disclosure relates generally to a wireless communication system, and more particularly to, for example, but not limited to, context transfer in wireless networks.

### BACKGROUND

Wireless local area network (WLAN) technology has evolved toward increasing data rates and continues its growth in various markets such as home, enterprise and hotspots over the years since the late 1990s. WLAN allows devices to access the internet in the 2.4 GHZ, 5 GHZ, 6 GHz or 60 GHz frequency bands. WLANs are based on the Institute of Electrical and Electronic Engineers (IEEE) 802.11 standards. IEEE 802.11 family of standards aims to increase speed and reliability and to extend the operating range of wireless networks.

WLAN devices are increasingly required to support a variety of delay-sensitive applications or real-time applications such as augmented reality (AR), robotics, artificial intelligence (AI), cloud computing, and unmanned vehicles. To implement extremely low latency and extremely high throughput required by such applications, multi-link operation (MLO) has been suggested for the WLAN. The WLAN is formed within a limited area such as a home, school, apartment, or office building by WLAN devices. Each WLAN device may have one or more stations (STAs) such as the access point (AP) STA and the non-access-point (non-AP) STA.

The MLO may enable a non-AP multi-link device (MLD) to set up multiple links with an AP MLD. Each of multiple links may enable channel access and frame exchanges between the non-AP MLD and the AP MLD independently, which may reduce latency and increase throughput.

The description set forth in the background section should not be assumed to be prior art merely because it is set forth in the background section. The background section may describe aspects or embodiments of the present disclosure.

### SUMMARY

An aspect of the disclosure provides a non-access point (AP) multi-link device (MLD) in a wireless network. The non-AP MLD comprises one or more stations (STAs) affiliated with the non-AP MLD; and a processor coupled to the one or more STAs. The processor is configured to transmit, to an AP MLD currently associated with the non-AP MLD, a first request frame including a preparation request for roaming from the AP MLD to a target AP MLD, the preparation request including (i) a medium access control (MAC) address for the target AP MLD and (ii) per-STA profile for each affiliated STA that the non-AP MLD requests. The processor is configured to receive, from the AP MLD, a first response frame indicating that the requested preparation is successful, the first response frame including an association identifier (AID) that is assigned to the non-AP MLD by the target AP MLD.

In an embodiment, the first request frame includes information indicating whether the non-AP MLD requests one or more contexts not to be transferred from the AP MLD to the target AP MLD.

In an embodiment, one or more contexts established between the non-AP MLD and the AP MLD are transferred from the AP MLD to the target AP MLD.

In an embodiment, stream classification service (SCS) descriptors of one or more SCS established with the AP MLD are transferred from the AP MLD to the target AP MLD.

In an embodiment, mirrored stream classification service (MSCS) descriptor of an MSCS established with the AP MLD are transferred from the AP MLD to the target AP MLD.

In an embodiment, the processor is further configured to receive, from the AP MLD, a frame that includes a time deadline indicating a time value between the first response frame indicating that the requested preparation is successful and an execution phase by which the non-AP MLD is to transition from the AP MLD to the target AP MLD.

In an embodiment, the processor is further configured to transmit, to the AP MLD within the time deadline, a second request frame including an execution request to transition to the target AP MLD.

In an embodiment, the first request frame includes information indicating whether the MAC address for target AP MLD is present.

In an embodiment, the first frame includes a field that includes a first value to indicate the preparation request.

In an embodiment, the AP MLD and the target AP MLD are part of a same seamless mobility domain (SMD).

An aspect of the disclosure provides an access point (AP) multi-link device (MLD) in a wireless network. The AP MLD comprises one or more APs affiliated with the AP MLD and a processor coupled to the one or more APs. The processor is configured to receive, from a non-AP MLD currently associated with the AP MLD, a first request frame including a preparation request for roaming from the AP MLD to a target AP MLD, the preparation request including (i) a medium access control (MAC) address for the target AP MLD and (ii) per-station (STA) profile for each affiliated STA that the non-AP MLD requests. The process is configured to transmit, to the non-AP MLD, a first response frame indicating that the requested preparation is successful, the first response frame including an association identifier (AID) that is assigned to the non-AP MLD by the target AP MLD.

In an embodiment, the first request frame includes information indicating whether the non-AP MLD requests one or more contexts not to be transferred from the AP MLD to the target AP MLD.

In an embodiment, the processor is further configured to transfer one or more contexts established between the non-AP MLD and the AP MLD from the AP MLD to the target AP MLD.

In an embodiment, the processor is further configured to transfer stream classification service (SCS) descriptors of one or more SCS established with the non-AP MLD from the AP MLD to the target AP MLD.

In an embodiment, the processor is further configured to transfer mirrored stream classification service (MSCS) descriptor of an MSCS established with the non-AP MLD from the AP MLD to the target AP MLD.

In an embodiment, the processor is further configured to transmit, to the non-AP MLD, a frame that includes a time deadline indicating a time value between the first response frame indicating that the requested preparation is successful and an execution phase by which the non-AP MLD is to transition from the AP MLD to the target AP MLD.

In an embodiment, the processor is further configured to receive, from the non-AP MLD within the time deadline, a second request frame including an execution request to transition to the target AP MLD.

In an embodiment, the first request frame includes information indicating whether the MAC address for target AP MLD is present.

In an embodiment, the first frame includes a field that includes a first value to indicate the preparation request.

In an embodiment, the AP MLD and the target AP MLD are part of a same seamless mobility domain (SMD).

### BRIEF DESCRIPTION OF THE DRAWINGS

FIG. 1 illustrates an example of a wireless network in accordance with an embodiment.

FIG. 2A illustrates an example of AP in accordance with an embodiment.

FIG. 2B illustrates an example of STA in accordance with an embodiment.

FIG. 3 illustrates an example of multi-link communication operation in accordance with an embodiment.

FIG. 4 illustrates stages of a mobility handover procedure in accordance with an embodiment.

FIG. 5 illustrates a logical AP MLD in accordance with an embodiment.

FIG. 6 illustrates a baseline roaming procedure with context transfer in accordance with an embodiment.

FIG. 7 illustrates a timeline of an example context transfer in accordance with an embodiment.

FIG. 8 illustrates a timeline of a STA performing a roaming in accordance with an embodiment.

FIG. 9 illustrates a timeline of performing roaming with a dynamic context transfer in accordance with an embodiment.

FIG. 10 illustrates a roaming response that includes a context transfer response in accordance with an embodiment.

FIG. 11 illustrates a timeline of performing a roaming in accordance with an embodiment.

FIG. 12 illustrates a flow chart of an example process by an AP of performing a context transfer advertisement in accordance with an embodiment.

FIG. 13 illustrates a flow chart of an example process by an AP of rejecting a context transfer request in accordance with an embodiment

FIG. 14 illustrates an example of a context transfer in a seamless roaming domain in accordance with an embodiment.

FIG. 15 illustrates a context transfer indication element that may be included in a link reconfiguration request frame in accordance with an embodiment.

FIG. 16 illustrates a context transfer indication element in accordance with an embodiment.

FIG. 17 illustrates an example format of target AP MLD identifier element of a link reconfiguration request frame in accordance with an embodiment.

FIG. 18 illustrates an example of a target AP MLD identifier in a common info field of a reconfiguration multi-link element in accordance with an embodiment.

FIG. 19 illustrates an example of a target AP MLD identifier in a common info field of a reconfiguration multi-link element in accordance with an embodiment.

FIG. 20 illustrates an example of a presence indication bit for a target AP MLD MAC address in a common info field of a reconfiguration multi-link element in accordance with an embodiment.

FIG. 21 illustrates an example format of a deadline or timeout element in accordance with an embodiment.

FIG. 22 illustrates an example of a context transfer indication element in accordance with an embodiment.

FIG. 23 illustrates an example format of an SMD information element in accordance with an embodiment.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below, in connection with the appended drawings, is intended as a description of various implementations and is not intended to represent the only implementations in which the subject technology may be practiced. Rather, the detailed description includes specific details for the purpose of providing a thorough understanding of the inventive subject matter.

As those skilled in the art would realize, the described implementations may be modified in various ways, all without departing from the scope of the present disclosure. Accordingly, the drawings and description are to be regarded as illustrative in nature and not restrictive. Like reference numerals designate like elements.

The following description is directed to certain implementations for the purpose of describing the innovative aspects of this disclosure. However, a person having ordinary skill in the art will readily recognize that the teachings herein can be applied in a multitude of different ways. The examples in this disclosure are based on WLAN communication according to the Institute of Electrical and Electronics Engineers (IEEE) 802.11 standard, including IEEE 802.11be standard and any future amendments to the IEEE 802.11 standard. However, the described embodiments may be implemented in any device, system or network that is capable of transmitting and receiving radio frequency (RF) signals according to the IEEE 802.11 standard, the Bluetooth standard, Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1xEV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), 5G NR (New Radio), AMPS, or other known signals that are used to communicate within a wireless, cellular or internet of things (IOT) network, such as a system utilizing 3G, 4G, 5G, 6G, or further implementations thereof, technology.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

Multi-link operation (MLO) is a key feature that is currently being developed by the standards body for next generation extremely high throughput (EHT) Wi-Fi systems in IEEE 802.11be. The Wi-Fi devices that support MLO are referred to as multi-link devices (MLD). With MLO, it is possible for a non-AP MLD to discover, authenticate, associate, and set up multiple links with an AP MLD. Channel access and frame exchange is possible on each link between the AP MLD and non-AP MLD.

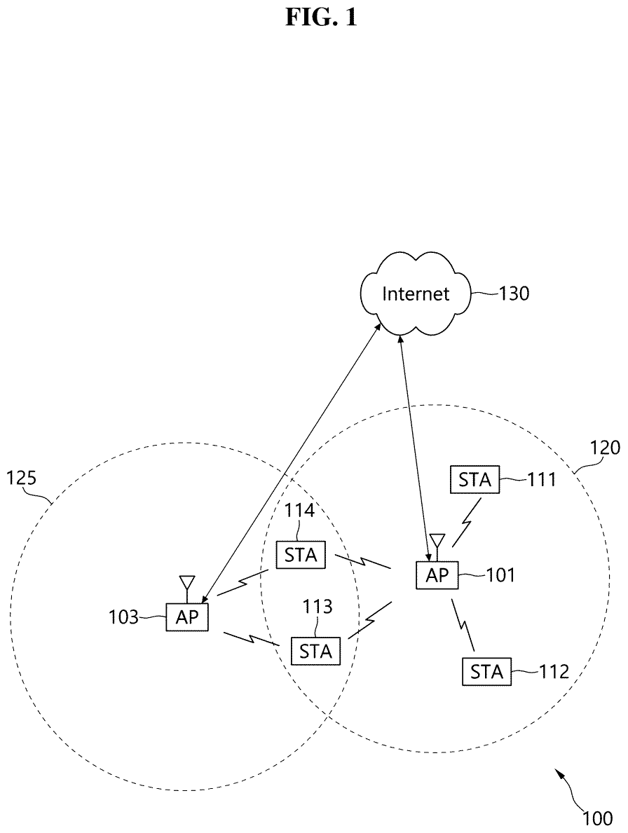

FIG. 1 shows an example of a wireless network 100 in accordance with an embodiment. The embodiment of the wireless network 100 shown in FIG. 1 is for illustrative purposes only. Other embodiments of the wireless network 100 could be used without departing from the scope of this disclosure.

As shown in FIG. 1, the wireless network 100 may include a plurality of wireless communication devices. Each wireless communication device may include one or more stations (STAs). The STA may be a logical entity that is a singly addressable instance of a medium access control (MAC) layer and a physical (PHY) layer interface to the wireless medium. The STA may be classified into an access point (AP) STA and a non-access point (non-AP) STA. The AP STA may be an entity that provides access to the distribution system service via the wireless medium for associated STAs. The non-AP STA may be a STA that is not contained within an AP-STA. For the sake of simplicity of description, an AP STA may be referred to as an AP and a non-AP STA may be referred to as a STA. In the example of FIG. 1, APs 101 and 103 are wireless communication devices, each of which may include one or more AP STAs. In such embodiments, APs 101 and 103 may be AP multi-link device (MLD). Similarly, STAs 111-114 are wireless communication devices, each of which may include one or more non-AP STAs. In such embodiments, STAs 111-114 may be non-AP MLD.

The APs 101 and 103 communicate with at least one network 130, such as the Internet, a proprietary Internet Protocol (IP) network, or other data network. The AP 101 provides wireless access to the network 130 for a plurality of stations (STAs) 111-114 with a coverage are 120 of the AP 101. The APs 101 and 103 may communicate with each other and with the STAs using Wi-Fi or other WLAN communication techniques.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

In FIG. 1, dotted lines show the approximate extents of the coverage area 120 and 125 of APs 101 and 103, which are shown as approximately circular for the purposes of illustration and explanation. It should be clearly understood that coverage areas associated with APs, such as the coverage areas 120 and 125, may have other shapes, including irregular shapes, depending on the configuration of the APs.

As described in more detail below, one or more of the APs may include circuitry and/or programming for management of MU-MIMO and OFDMA channel sounding in WLANs. Although FIG. 1 shows one example of a wireless network 100, various changes may be made to FIG. 1. For example, the wireless network 100 could include any number of APs and any number of STAs in any suitable arrangement. Also, the AP 101 could communicate directly with any number of STAs and provide those STAs with wireless broadband access to the network 130. Similarly, each AP 101 and 103 could communicate directly with the network 130 and provides STAs with direct wireless broadband access to the network 130. Further, the APs 101 and/or 103 could provide access to other or additional external networks, such as external telephone networks or other types of data networks.

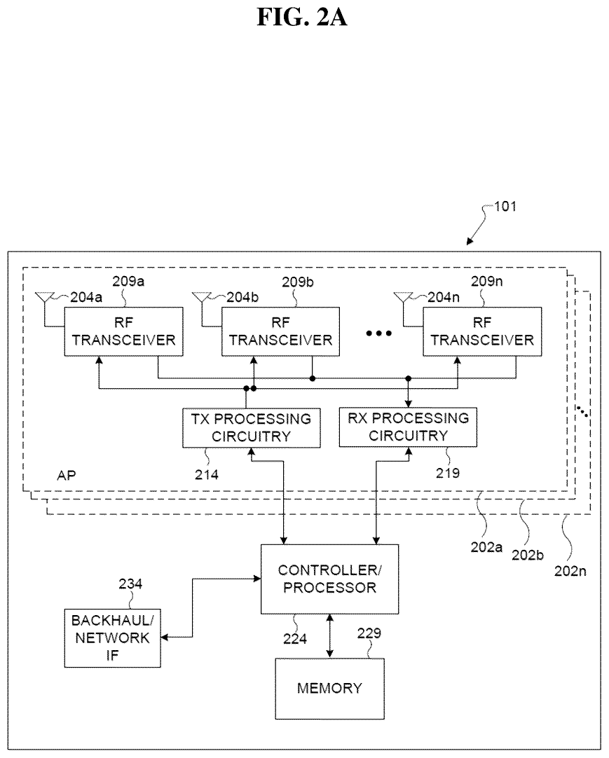

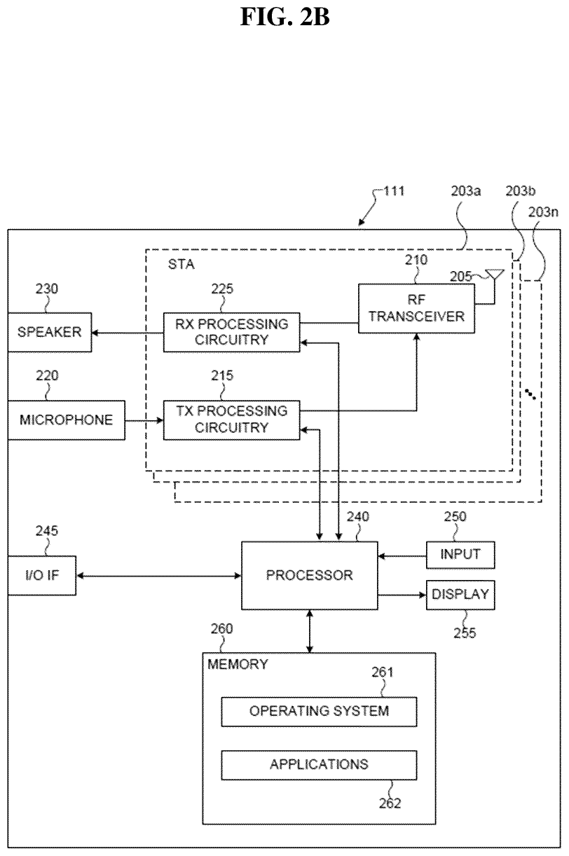

FIG. 2A shows an example of AP 101 in accordance with an embodiment. The embodiment of the AP 101 shown in FIG. 2A is for illustrative purposes, and the AP 103 of FIG. 1 could have the same or similar configuration. However, APs come in a wide range of configurations, and FIG. 2A does not limit the scope of this disclosure to any particular implementation of an AP.

As shown in FIG. 2A, the AP 101 may include multiple antennas 204a-204n, multiple radio frequency (RF) transceivers 209a-209n, transmit (TX) processing circuitry 214, and receive (RX) processing circuitry 219. The AP 101 also may include a controller/processor 224, a memory 229, and a backhaul or network interface 234. The RF transceivers 209a-209n receive, from the antennas 204a-204n, incoming RF signals, such as signals transmitted by STAs in the network 100. The RF transceivers 209a-209n down-convert the incoming RF signals to generate intermediate (IF) or baseband signals. The IF or baseband signals are sent to the RX processing circuitry 219, which generates processed baseband signals by filtering, decoding, and/or digitizing the baseband or IF signals. The RX processing circuitry 219 transmits the processed baseband signals to the controller/processor 224 for further processing.

The TX processing circuitry 214 receives analog or digital data (such as voice data, web data, e-mail, or interactive video game data) from the controller/processor 224. The TX processing circuitry 214 encodes, multiplexes, and/or digitizes the outgoing baseband data to generate processed baseband or IF signals. The RF transceivers 209a-209n receive the outgoing processed baseband or IF signals from the TX processing circuitry 214 and up-converts the baseband or IF signals to RF signals that are transmitted via the antennas 204a-204n.

The controller/processor 224 can include one or more processors or other processing devices that control the overall operation of the AP 101. For example, the controller/processor 224 could control the reception of uplink signals and the transmission of downlink signals by the RF transceivers 209a-209n, the RX processing circuitry 219, and the TX processing circuitry 214 in accordance with well-known principles. The controller/processor 224 could support additional functions as well, such as more advanced wireless communication functions. For instance, the controller/processor 224 could support beam forming or directional routing operations in which outgoing signals from multiple antennas 204a-204n are weighted differently to effectively steer the outgoing signals in a desired direction. The controller/processor 224 could also support OFDMA operations in which outgoing signals are assigned to different subsets of subcarriers for different recipients (e.g., different STAs 111-114). Any of a wide variety of other functions could be supported in the AP 101 by the controller/processor 224 including a combination of DL MU-MIMO and OFDMA in the same transmit opportunity. In some embodiments, the controller/processor 224 may include at least one microprocessor or microcontroller. The controller/processor 224 is also capable of executing programs and other processes resident in the memory 229, such as an OS. The controller/processor 224 can move data into or out of the memory 229 as required by an executing process.

The controller/processor 224 is also coupled to the backhaul or network interface 234. The backhaul or network interface 234 allows the AP 101 to communicate with other devices or systems over a backhaul connection or over a network. The interface 234 could support communications over any suitable wired or wireless connection(s). For example, the interface 234 could allow the AP 101 to communicate over a wired or wireless local area network or over a wired or wireless connection to a larger network (such as the Internet). The interface 234 may include any suitable structure supporting communications over a wired or wireless connection, such as an Ethernet or RF transceiver. The memory 229 is coupled to the controller/processor 224. Part of the memory 229 could include a RAM, and another part of the memory 229 could include a Flash memory or other ROM.

As described in more detail below, the AP 101 may include circuitry and/or programming for management of channel sounding procedures in WLANs. Although FIG. 2A illustrates one example of AP 101, various changes may be made to FIG. 2A. For example, the AP 101 could include any number of each component shown in FIG. 2A. As a particular example, an AP could include a number of interfaces 234, and the controller/processor 224 could support routing functions to route data between different network addresses. As another example, while shown as including a single instance of TX processing circuitry 214 and a single instance of RX processing circuitry 219, the AP 101 could include multiple instances of each (such as one per RF transceiver). Alternatively, only one antenna and RF transceiver path may be included, such as in legacy APs. Also, various components in FIG. 2A could be combined, further subdivided, or omitted and additional components could be added according to particular needs.

As shown in FIG. 2A, in some embodiments, the AP 101 may be an AP MLD that includes multiple APs 202a-202n. Each AP 202a-202n is affiliated with the AP MLD 101 and includes multiple antennas 204a-204n, multiple radio frequency (RF) transceivers 209a-209n, transmit (TX) processing circuitry 214, and receive (RX) processing circuitry 219. Each APs 202a-202n may independently communicate with the controller/processor 224 and other components of the AP MLD 101. FIG. 2A shows that each AP 202a-202n has separate multiple antennas, but each AP 202a-202n can share multiple antennas 204a-204n without needing separate multiple antennas. Each AP 202a-202n may represent a physical (PHY) layer and a lower media access control (MAC) layer.

FIG. 2B shows an example of STA 111 in accordance with an embodiment. The embodiment of the STA 111 shown in FIG. 2B is for illustrative purposes, and the STAs 111-114 of FIG. 1 could have the same or similar configuration. However, STAs come in a wide variety of configurations, and FIG. 2B does not limit the scope of this disclosure to any particular implementation of a STA.

As shown in FIG. 2B, the STA 111 may include antenna(s) 205, a RF transceiver 210, TX processing circuitry 215, a microphone 220, and RX processing circuitry 225. The STA 111 also may include a speaker 230, a controller/processor 240, an input/output (I/O) interface (IF) 245, a touchscreen 250, a display 255, and a memory 260. The memory 260 may include an operating system (OS) 261 and one or more applications 262.

The RF transceiver 210 receives, from the antenna(s) 205, an incoming RF signal transmitted by an AP of the network 100. The RF transceiver 210 down-converts the incoming RF signal to generate an IF or baseband signal. The IF or baseband signal is sent to the RX processing circuitry 225, which generates a processed baseband signal by filtering, decoding, and/or digitizing the baseband or IF signal. The RX processing circuitry 225 transmits the processed baseband signal to the speaker 230 (such as for voice data) or to the controller/processor 240 for further processing (such as for web browsing data).

The TX processing circuitry 215 receives analog or digital voice data from the microphone 220 or other outgoing baseband data (such as web data, e-mail, or interactive video game data) from the controller/processor 240. The TX processing circuitry 215 encodes, multiplexes, and/or digitizes the outgoing baseband data to generate a processed baseband or IF signal. The RF transceiver 210 receives the outgoing processed baseband or IF signal from the TX processing circuitry 215 and up-converts the baseband or IF signal to an RF signal that is transmitted via the antenna(s) 205.

The controller/processor 240 can include one or more processors and execute the basic OS program 261 stored in the memory 260 in order to control the overall operation of the STA 111. In one such operation, the controller/processor 240 controls the reception of downlink signals and the transmission of uplink signals by the RF transceiver 210, the RX processing circuitry 225, and the TX processing circuitry 215 in accordance with well-known principles. The controller/processor 240 can also include processing circuitry configured to provide management of channel sounding procedures in WLANs. In some embodiments, the controller/processor 240 may include at least one microprocessor or microcontroller.

The controller/processor 240 is also capable of executing other processes and programs resident in the memory 260, such as operations for management of channel sounding procedures in WLANs. The controller/processor 240 can move data into or out of the memory 260 as required by an executing process. In some embodiments, the controller/processor 240 is configured to execute a plurality of applications 262, such as applications for channel sounding, including feedback computation based on a received null data packet announcement (NDPA) and null data packet (NDP) and transmitting the beamforming feedback report in response to a trigger frame (TF). The controller/processor 240 can operate the plurality of applications 262 based on the OS program 261 or in response to a signal received from an AP. The controller/processor 240 is also coupled to the I/O interface 245, which provides STA 111 with the ability to connect to other devices such as laptop computers and handheld computers. The I/O interface 245 is the communication path between these accessories and the main controller/processor 240.

The controller/processor 240 is also coupled to the input 250 (such as touchscreen) and the display 255. The operator of the STA 111 can use the input 250 to enter data into the STA 111. The display 255 may be a liquid crystal display, light emitting diode display, or other display capable of rendering text and/or at least limited graphics, such as from web sites. The memory 260 is coupled to the controller/processor 240. Part of the memory 260 could include a random access memory (RAM), and another part of the memory 260 could include a Flash memory or other read-only memory (ROM).

Although FIG. 2B shows one example of STA 111, various changes may be made to FIG. 2B. For example, various components in FIG. 2B could be combined, further subdivided, or omitted and additional components could be added according to particular needs. In particular examples, the STA 111 may include any number of antenna(s) 205 for MIMO communication with an AP 101. In another example, the STA 111 may not include voice communication or the controller/processor 240 could be divided into multiple processors, such as one or more central processing units (CPUs) and one or more graphics processing units (GPUs). Also, while FIG. 2B illustrates the STA 111 configured as a mobile telephone or smartphone, STAs could be configured to operate as other types of mobile or stationary devices.

As shown in FIG. 2B, in some embodiments, the STA 111 may be a non-AP MLD that includes multiple STAs 203a-203n. Each STA 203a-203n is affiliated with the non-AP MLD 111 and includes an antenna(s) 205, a RF transceiver 210, TX processing circuitry 215, and RX processing circuitry 225. Each STAs 203a-203n may independently communicate with the controller/processor 240 and other components of the non-AP MLD 111. FIG. 2B shows that each STA 203a-203n has a separate antenna, but each STA 203a-203n can share the antenna 205 without needing separate antennas. Each STA 203a-203n may represent a physical (PHY) layer and a lower media access control (MAC) layer.

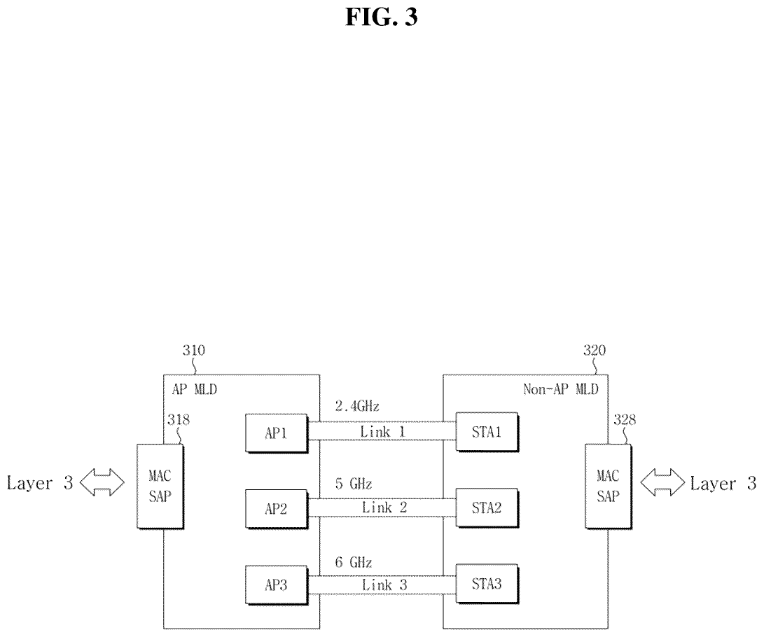

FIG. 3 shows an example of multi-link communication operation in accordance with an embodiment. The multi-link communication operation may be usable in IEEE 802.11be standard and any future amendments to IEEE 802.11 standard. In FIG. 3, an AP MLD 310 may be the wireless communication device 101 and 103 in FIG. 1 and a non-AP MLD 220 may be one of the wireless communication devices 111-114 in FIG. 1.

As shown in FIG. 3, the AP MLD 310 may include a plurality of affiliated APs, for example, including AP 1, AP 2, and AP 3. Each affiliated AP may include a PHY interface to wireless medium (Link 1, Link 2, or Link 3). The AP MLD 310 may include a single MAC service access point (SAP) 318 through which the affiliated APs of the AP MLD 310 communicate with a higher layer (Layer 3 or network layer). Each affiliated AP of the AP MLD 310 may have a MAC address (lower MAC address) different from any other affiliated APs of the AP MLD 310. The AP MLD 310 may have a MLD MAC address (upper MAC address) and the affiliated APs share the single MAC SAP 318 to Layer 3. Thus, the affiliated APs share a single IP address, and Layer 3 recognizes the AP MLD 310 by assigning the single IP address.

The non-AP MLD 320 may include a plurality of affiliated STAs, for example, including STA 1, STA 2, and STA 3. Each affiliated STA may include a PHY interface to the wireless medium (Link 1, Link 2, or Link 3). The non-AP MLD 320 may include a single MAC SAP 328 through which the affiliated STAs of the non-AP MLD 320 communicate with a higher layer (Layer 3 or network layer). Each affiliated STA of the non-AP MLD 320 may have a MAC address (lower MAC address) different from any other affiliated STAs of the non-AP MLD 320. The non-AP MLD 320 may have a MLD MAC address (upper MAC address) and the affiliated STAs share the single MAC SAP 328 to Layer 3. Thus, the affiliated STAs share a single IP address, and Layer 3 recognizes the non-AP MLD 320 by assigning the single IP address.

The AP MLD 310 and the non-AP MLD 320 may set up multiple links between their affiliate APs and STAs. In this example, the AP 1 and the STA 1 may set up Link 1 which operates in 2.4 GHz band. Similarly, the AP 2 and the STA 2 may set up Link 2 which operates in 5 GHZ band, and the AP 3 and the STA 3 may set up Link 3 which operates in 6 GHz band. Each link may enable channel access and frame exchange between the AP MLD 310 and the non-AP MLD 320 independently, which may increase date throughput and reduce latency. Upon associating with an AP MLD on a set of links (setup links), each non-AP device is assigned a unique association identifier (AID).

The following documents are hereby incorporated by reference in their entirety into the present disclosure as if fully set forth herein: i) IEEE 802.11-2020, “Wireless LAN Medium Access Control (MAC) and Physical Layer (PHY) Specifications,” ii) IEEE 802.11ax-2021, “Wireless LAN Medium Access Control (MAC) and Physical Layer (PHY) Specifications,” and iii) IEEE P802.11be/D5.0, “Wireless LAN Medium Access Control (MAC) and Physical Layer (PHY) Specifications.

As users move around an environment while holding a STA device, a signal strength of the STA to its connected AP can vary. If a user's movement causes a significant decrease in a signal strength, a handover may be necessary. During the handover process, a STA may switch from an associated AP, which may be referred to herein as current AP (CAP), to a new AP.

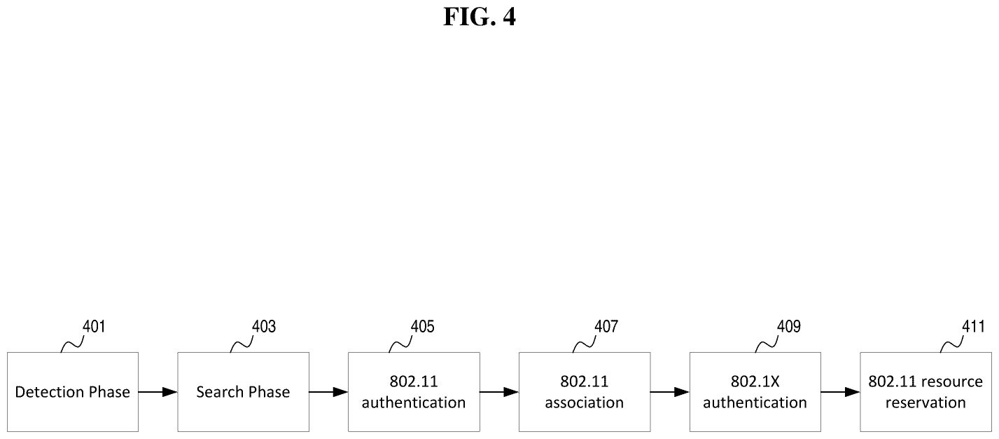

FIG. 4 illustrates stages of a mobility handover procedure in accordance with an embodiment. As shown in FIG. 4, in legacy devices without any mobility support, the handover procedure may involve several steps, including a detection phase 401, a search phase 403, an 802.11 authentication phase 405, an 802.11 association phase 407, an 802.1X authentication phase 409, and an 802.11 resource reservation phase 411.

During the detection phase 401, a STA may determine that there is a need for a handover. The procedures to detect a need for handover may be vendor specific. For instance, a particular vendor implementation may choose to trigger a handover when the signal strength to the currently associated AP drops below a certain threshold.

The detection phase 401 may be followed by a search phase 403. During the search phase 403, the STA may search for new APs to associate with. During the search phase 403, the STA may perform a scan of different channels to identify APs in the vicinity. This can be done either passively (e.g., listening to beacons on a particular channel) or actively (e.g., by the use of probe request and response procedure).

After the scanning procedure is complete, the next step is to perform 802.11 authentication (open system or shared key based) 405. Once the STA is authenticated, the next step is to perform 802.11 association 807. Introduced in IEEE 802.11i amendment, the 802.1X authentication phase 409 may include an EAP authentication between the STA and a AAA server with the assistance of the AP. Finally, during the 802.11 resource reservation phase 411, the STA may set up various resources at the new AP. For example, the STA can perform quality of service (QoS) reservation, BA setup, etc. with the newly associated AP.

Typically, during a handover, there can be a disruption in the connection as the setup procedure operates in a break-before-make manner. This can cause an impact on user experience especially with multimedia services which can suffer from session disruptions due to the high delay encountered during handover procedure.

In order to reduce the handover delay, a number of procedures have been introduced in several standards. The focus of these procedures is to remove or reduce the delay encountered in various steps of the handover procedure. In 2008, IEEE 802.11r introduced a fast transition roaming which may eliminate the need for the authentication step (e.g., 802.11 authentication 405 in FIG. 4) during the handover. In 2011, IEEE 802.11k introduced assisted roaming which may reduce the search phase (e.g., search phase 403 in FIG. 4) by allowing the STA to request the AP to send channel information of candidate neighbor APs. In 2011, IEEE 802.11v also introduced network assisted roaming to assist the search phase. Thus, with a combination of IEEE 802.11v and IEEE 802.11k support, the search time can be reduced by enabling the device to scan only those channels on which APs in the vicinity operate. In IEEE 802.11be, the fast BSS transition procedure was extended to cover the case of multi-link operation (MLO). This procedure helps to reduce the delays encountered due to IEE 802.11 resource reservation (e.g., 802.11 resource reservation 411 in FIG. 4).

In next generation wireless network, a number of APs can coordinate with each other to form what may be referred to herein as a seamless mobility domain (SMD). As described herein, a seamless mobility domain may be referred to as a seamless roaming domain, non-collocated AP MLD, logical AP MLD, among others. With a seamless mobility domain, roaming from one AP to another AP can be done seamlessly by a STA (e.g., without requiring (Re)association). In some embodiments, the STA may indicate to the STA's current AP the candidate APs that the STA may intend to roam to. The current AP may then coordinate with the candidate APs to ensure a seamless roam for the STA (e.g., preparing potential neighbor or target AP(s) for the roam). In particular, when the STA detects a need to roam, the STA can inform the current AP about which neighbor AP the STA intends to roam to and the current AP may communicate with the one or more neighbor APs to determine whether the neighbor APs are available for roaming and provide a response message to the STA, upon which the STA may roam to a neighbor AP that is available for roaming.

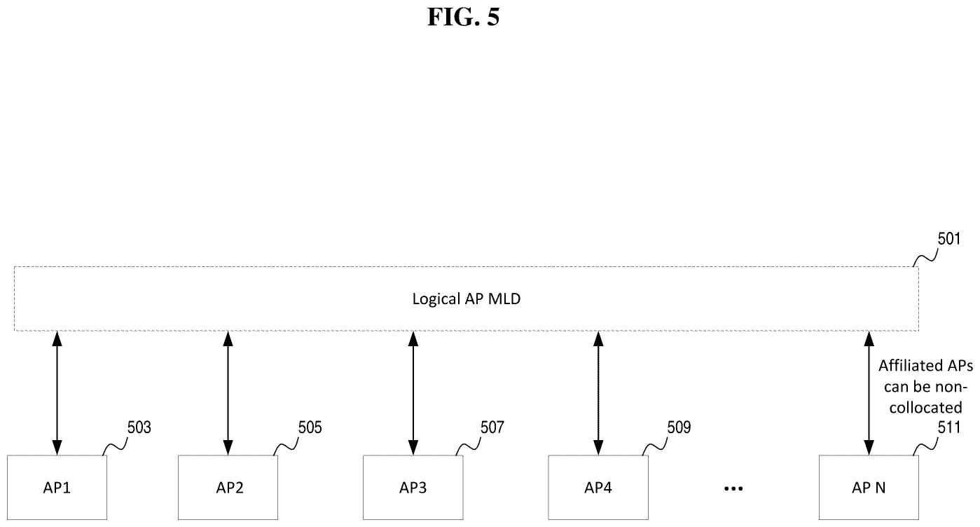

FIG. 5 illustrates a logical AP MLD in accordance with an embodiment. The logical AP MLD 501 may include several APs which can be non-collocated or not located on a same physical device. As illustrated, the logical AP MLD includes AP1 501, AP2 505, AP3 507, AP4 509 up to APN 511, where the APs may be non-collocated with the logical AP MLD 501. The structure of a logical AP MLD may be different than that of an AP MLD as provided by the IEEE 802.11be standard, which considers collocated APs (i.e., APs located on a same physical device) affiliated with an AP MLD.

As illustrated in FIG. 5, AP 1 503 to AP N 511 may be non-collocated or on different physical devices. Furthermore, one or more of these APs 503-511 can have a common data path to a router or a central controller. The APs 503-511 may form a logical AP MLD 501. The logical AP MLD may be able to reduce various delays, including delays related to association and/or authentication phases illustrated in FIG. 4 as the STA may not need to perform association and authentication during handover. In some embodiments, a logical AP MLD may be defined using various kinds of connections between physical APs that may enable the APs to perform coordination amongst themselves.

In some embodiments, when a STA roams from a first AP to a second AP, one or more contexts that have been setup by the STA with the first AP may be transferred to the second AP. The context may include one or more parameters related to one or more features that the STA is using to communicate with the first AP. Table 1 below provides an example of a list of contexts that can be setup for different use cases in accordance with an embodiment. In some embodiments, contexts can be categorized into one or more groups, including static or near static contexts and dynamic contexts. As described herein, near static contexts may be referred to as static contexts and vice versa. In some embodiments, static or near static contexts may include parameters that do not change or may change slightly within a short threshold time period (e.g., on a short time scale). In some embodiments, dynamic contexts may include parameters that may change within a short threshold period or within a short time scale.

Table 1 illustrates an example of contexts and their categorization in accordance with an embodiment.

TABLE 1

| Context | Type |
|---|---|
| Sequence Number (SN) | Dynamic |
| Packet Number (PN) | Dynamic |
| Block ACK (BA) parameters. e.g., SN | Dynamic |
| Security keys. e.g., pairwise transient keys | Near Static |
| (PTKs), group terminal keys (GTKs), among | |
| others. | |
| BA setup | Near Static |
| Stream classification service (SCS) or | Near Static |
| mirrored stream classification service (MSCS) | |
| Emergency Preparedness Communication | Near Static |
| Service (EPCS) | |
| Target wake time (TWT) and variants | Near Static |
| (restricted TWT (rTWT), blind TWT | |
| (bTWT), individual TWT, among others) | |
| Peer-to-peer (P2P) TWT/Coexistence | Near Static |
| (CoEx) Sessions | |
| Power Save (PS): Dynamic spatial | Near Static |
| multiplexing power save (SMPS), | |
| unscheduled power save delivery (UPSD), | |
| wireless network management (WNM), Intra | |
| physical protocol data unit power save | |
| (PPDU PS), among others | |
| Enhanced multi-link single-radio (EMLSR) | Near Static |
| setup | |
| Enhanced multi-link multi-radio (EMLMR) | Near Static |
| setup | |
| Physical layer (PHY) Capabilities | Near Static |

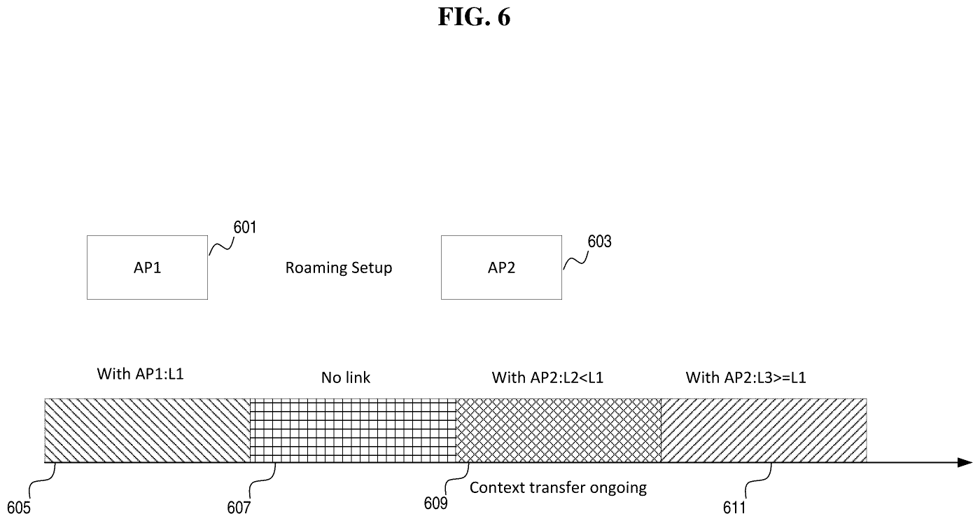

FIG. 6 illustrates a baseline roaming procedure with context transfer in accordance with an embodiment. In particular, FIG. 6 illustrates a first AP, AP1 601 and a second AP, AP2. In operation 605, the STA is associated with AP1 and a qualitative performance measure of a link established between the STA and AP1 is L1. In operation 607, the STA may decide to roam to AP2 603, and in a baseline roaming (e.g., without a seamless roaming), a link may not exist and roaming from AP1 to AP2 may require that the STA perform (re)ssociation, authentication, among other operations with AP2. In operation 609, the roaming may include a context transfer phase that may include a link setup between the STA and AP2, where the link may not include one or more of the contexts provided in Table 1, among others. Accordingly, if one or more contexts need to be setup again after roaming, the benefits of seamless roaming at layer 2 may be limited. In particular, the STA may need to re-setup one or more contexts and thus the link established with AP2 may not be performing at an optimal level. In particular, in operation 609, a qualitative measure of the link between the STA and AP2 is L2, which may be less than the qualitative measure L1 (e.g., L2<L1).

In operation 611, the context transfer procedure may be completed, after which the link between the STA and AP2 may now be performing at an optimal level, such that a qualitative measure of the link with AP2, L3, is now greater than the qualitative measure L1. However, using baseline roaming procedures may require using an extended period of time in order to re-setup contexts depending on a channel access time to exchange frames and time for processing and negotiation.

Accordingly, in some embodiments, a context transfer may be performed to transfer one or more contexts from a first AP to a second AP, and the context transfer may reduce a time needed for a link to reach an optimal performance level. In some embodiments, a context transfer may include an exchange of relevant information between APs, including between a first AP and a second AP, such that the second AP is aware of one or more parameters of one or more contexts when the STA roams to the second AP.

In some embodiments, a specification may specify one or more specific contexts that may be transferred during roaming (e.g., BA, SN, PN, among others). In some embodiments, a roaming procedure may be divided into two or more phases, including a preparation phase and a roaming phase. In some embodiments, the preparation phase may precede the roaming phase. In some embodiments, during a preparation phase, a current AP may perform a transfer of one or more near static contexts to a target AP. In some embodiments, the preparation phase can be initiated upon the request of the STA. In some embodiments, the current AP may inform the STA about one or more other context transfer responses from a target AP. In some embodiments, during a roaming phase, the current AP may perform a transfer of one or more dynamic contexts to the target AP.

In some embodiments, when a current AP performs a static context transfer, the current AP may provide a time deadline to the STA where the time deadline may be set by the target AP. In some embodiments, the time deadline may be a deadline by which the STA may be required to roam to the target AP in order for a context transfer to be valid at the target AP. In some embodiments, a target AP may specify one or more time deadlines for one or more contexts. (e.g., 100 ms for SCS, 500 ms for BA, 100 ms for EPCS, among others).

In some embodiments, a target AP may provide a single deadline for one or more contexts (e.g., a minimum deadline for one or more contexts for the AP). In some embodiments where there may be one deadline for one or more contexts from a target AP, a minimum of 100 ms for SCS may be specified as a single deadline.

In some embodiments, if the STA does not roam to the target AP before a time deadline, one or more of the corresponding contexts may need to be setup again with the target AP upon roaming. In some embodiments, if there is a single deadline and the STA does not roam to the target AP before this deadline, then one or more (e.g., all) of the contexts may need to be setup again with the target AP.

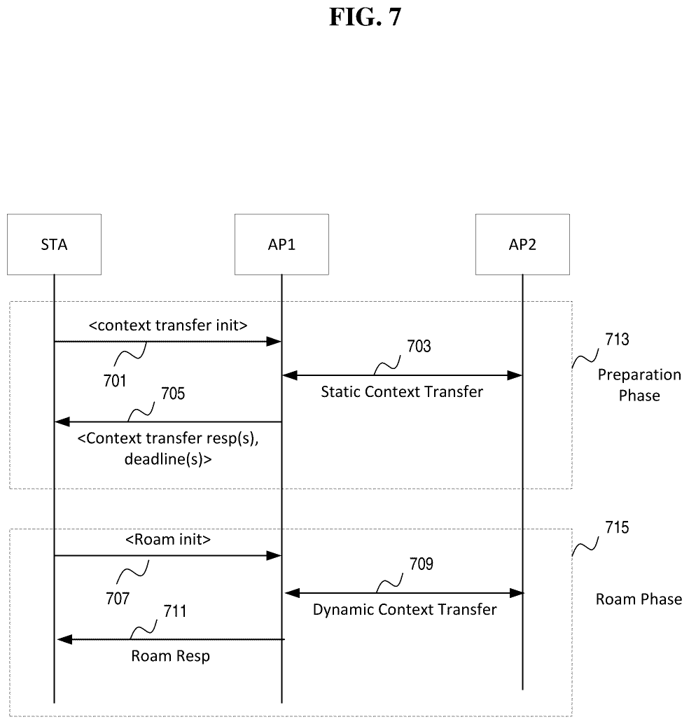

FIG. 7 illustrates a timeline of an example context transfer in accordance with an embodiment. In particular, FIG. 7 illustrates communication among a STA, a first AP, AP1, and a second AP, AP2. The communication includes a preparation phase 713 and a roam phase 713.

During the preparation phase, in operation 701, the STA transmits to AP1, a context transfer initiate message to request that AP1 initiate a context transfer to AP2. Accordingly, in operation 703, AP1 communicates with AP2 to perform a static context transfer of one or more static or near static contexts. In operation 705, AP1 transmits to the STA a context transfer response message. The context transfer response message may provide a status of the context transfer (e.g., successful or failed), and a time deadline by which the STA may need to perform roaming to AP2 in order for the transferred contexts to remain valid.

During the roam phase 715, in operation 707, the STA transmits to AP1, a roam initiate message to request AP1 to initiate a dynamic context transfer to AP2. Accordingly, in operation 709, AP1 communicates with AP2 to perform a dynamic context transfer that may include a transfer of one or more dynamic contexts. In operation 711, AP1 transmits a roam response message that may include a status of the dynamic context transfer (e.g., successful or failed).

In some embodiments, there may be one or more preparation phases. In some embodiments, the STA may perform a preparation phase several times. In some embodiments, there may be a limit on the number of preparation phases that a STA may perform.

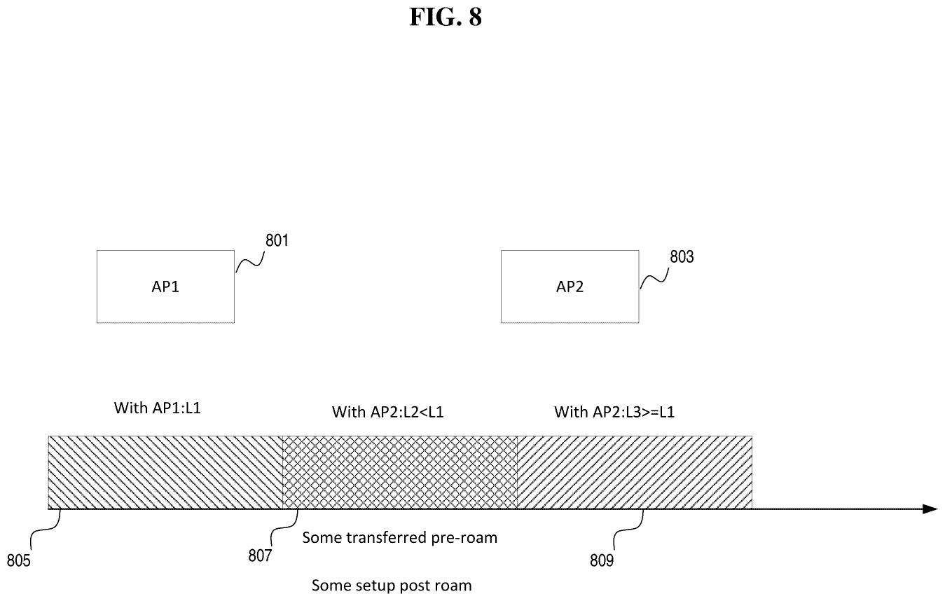

FIG. 8 illustrates a timeline of a STA performing a roaming in accordance with an embodiment. In particular, as compared to FIG. 6, the operation with no link (e.g., operation 607 in FIG. 6) is no longer present due to the seamless roaming in FIG. 8. Furthermore, the duration of operation 807 may be reduced (e.g., in comparison to operation 609 of FIG. 6) due to context transfer. In particular, FIG. 8 illustrates a first AP, AP1 801, and a second AP, AP2 803. In operation 805, a STA is associated with AP1 and a qualitative performance measure of a link established between the STA and AP1 is L1. In operation 807, the STA may decide to roam to AP2 803, and the roaming may include having one or more contexts already transferred pre-roam and one or more contexts transferred post-roam. In some embodiments, one or more near static contexts may be transferred prior to the roaming to AP2 and one or more dynamic contexts may be transferred during or after the roaming to AP2. Accordingly, during operation 807, the qualitative measure of the link is L2 which is less than L1 as some of the contexts may not have been transferred yet, including one or more dynamic contexts. In operation 809, the context transfers may be completed such that the static and dynamic contexts have been transferred, after which the link between the STA and AP 2 may now be performing at an optimal level, such that a qualitative measure of the link, L3, with AP2 is now greater than the qualitative measure L1 of the link with AP1.

In some embodiments, an AP that is capable of performing a context transfer to a target AP may advertise the AP's capability in one or more frames that the AP transmits (e.g., beacon frames, among others). In some embodiments, a STA may give a preference to APs with context transfer capabilities during AP selection procedure.

In some embodiments, a current AP may only perform a transfer of dynamic contexts to a target AP during roaming. Accordingly, the near static contexts may need to be setup again by the STA upon roaming to the target AP.

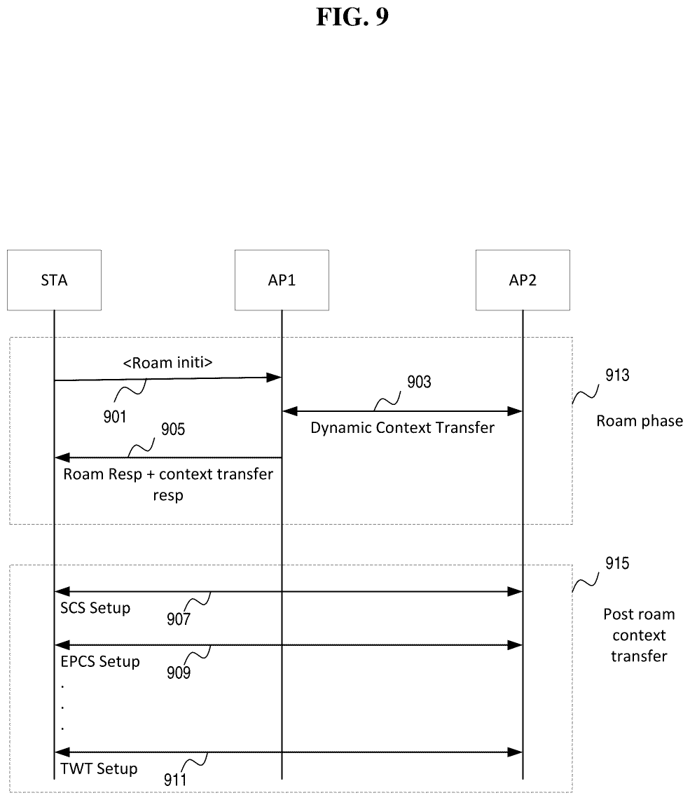

FIG. 9 illustrates a timeline of performing roaming with a dynamic context transfer in accordance with an embodiment. In particular, FIG. 9 illustrates communication among a STA, a first AP, AP1, and a second AP, AP2. The communication includes a roam phase 913 and a post roam context transfer phase 915.

During the roam phase 913, in operation 901, the STA transmits to AP1, a roam initiate message to request that AP1 initiate a dynamic context transfer to AP2. Accordingly, in operation 903, AP1 communicates with AP2 to perform a dynamic context transfer that may include transferring one or more dynamic contexts from AP1 to AP2. In operation 905, AP1 transmits to the STA a roam response and context transfer response message. The roam response and context transfer response message may provide a status of the dynamic context transfer (e.g., successful or failed).

During the post roam context transfer phase 915, the STA may communicate with AP2 to re-setup one or more static contexts. The communication may include setting up various static or near static contexts or agreements. In particular, in operation 907, the STA communicates with AP2 to setup a stream classification service (SCS) agreement. In operation 909, the STA communicates with AP2 to setup an EPCS agreement. In operation 911, the STA communicates with AP2 to setup a TWT agreement.

In some embodiments, one or more dynamic and/or static contexts may be transferred from a current AP to a target AP during a roaming phase. In some embodiments, a roaming response may include a context transfer response.

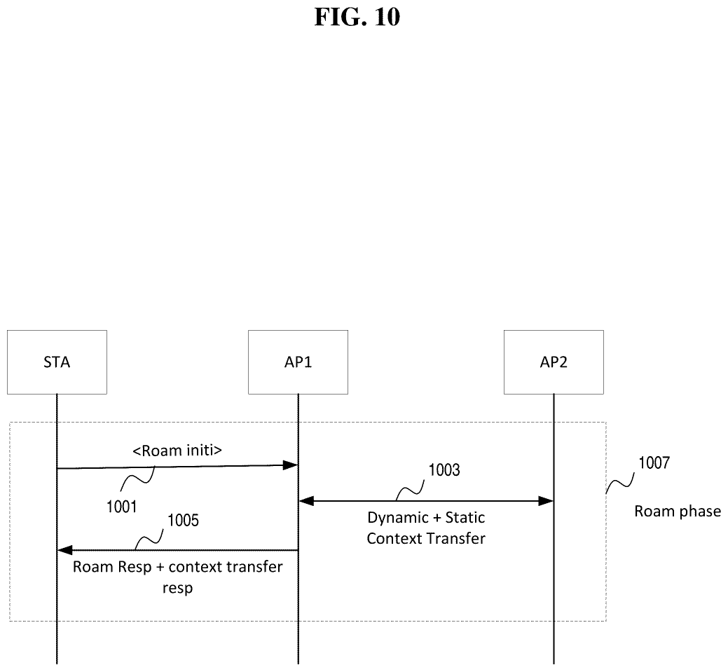

FIG. 10 illustrates a roaming response that includes a context transfer response in accordance with an embodiment. In particular, FIG. 10 illustrates communication among a STA, a first AP, AP1, and a second AP, AP2. The communication includes a roam phase 1007.

During the roam phase 1007, in operation 1001, the STA transmits to AP1, a roam initiate message to request that AP1 initiate a static and dynamic context transfer of one or more static contexts and one or more dynamic contexts to AP2. Accordingly, in operation 1003, AP1 communicates with AP2 to perform a dynamic context transfer and static context transfer. In operation 1005, AP1 transmits to the STA a roam response and context transfer response message. The roam response and context transfer response message may provide a status of the static and dynamic context transfer (e.g., successful or failed).

In some embodiments, an AP may attempt to transfer one or more (e.g., all) contexts that have been setup with a STA.

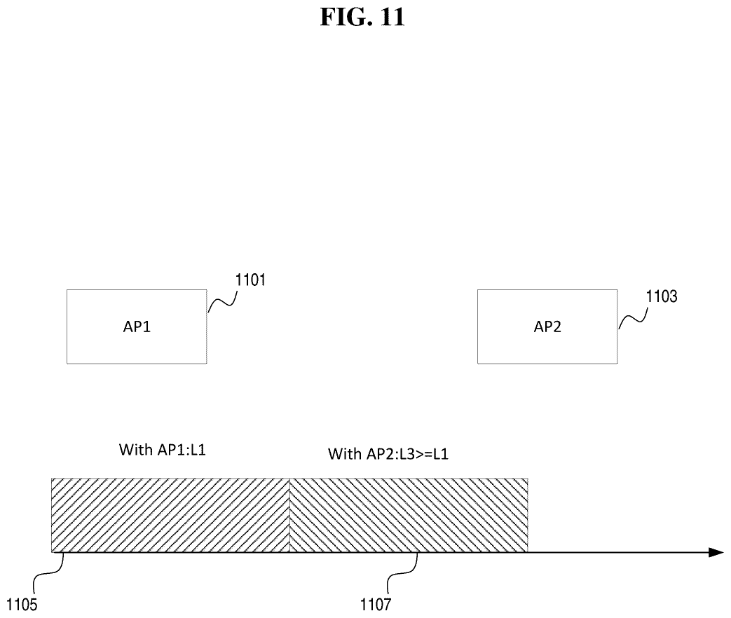

FIG. 11 illustrates a timeline of performing a roaming in accordance with an embodiment. In particular, FIG. 11 illustrates a first AP, AP1 1101, and a second AP, AP2 1103. In operation 1105, a STA may be associated with AP1 and a link established between the STA and AP1 may have a qualitative performance measure of L1. In operation 1107, the STA may perform roaming to AP2, and the link established between the STA and AP2 may have a qualitative performance measure of L3 which is greater than L1. Unlike the roaming examples of FIG. 8 and FIG. 6, the roaming operation in FIG. 11 may immediately provide a link that is operating at an optimal level as one or more static or dynamic contexts may have been already transferred from AP1 to AP2 prior to the roaming operation 1107.

In some embodiments, an AP may advertise (e.g., in beacon frames, among others) to a STA one or more contexts that the AP is capable of transferring and one or more contexts that the AP is not capable of transferring. A STA may use this information to determine which contexts may be transferrable and which contexts may need to be setup again at a target AP. A STA may use this information to determine one or more contexts to setup closer to roam and one or more contexts that may not be worth setting up closer to roam as they may need to be reset up again.

In some embodiments, an AP may advertise one or more target APs to which a context transfer may be performed. For example, a second AP may have informed a first AP about the second AP's constraints and of certain types of contexts that may not be transferable to the second AP, or if the second AP may not be within a context transfer domain of a first AP. In some embodiments, a STA may use the advertised information from an AP to determine whether the STA may request a context transfer to a particular target AP.

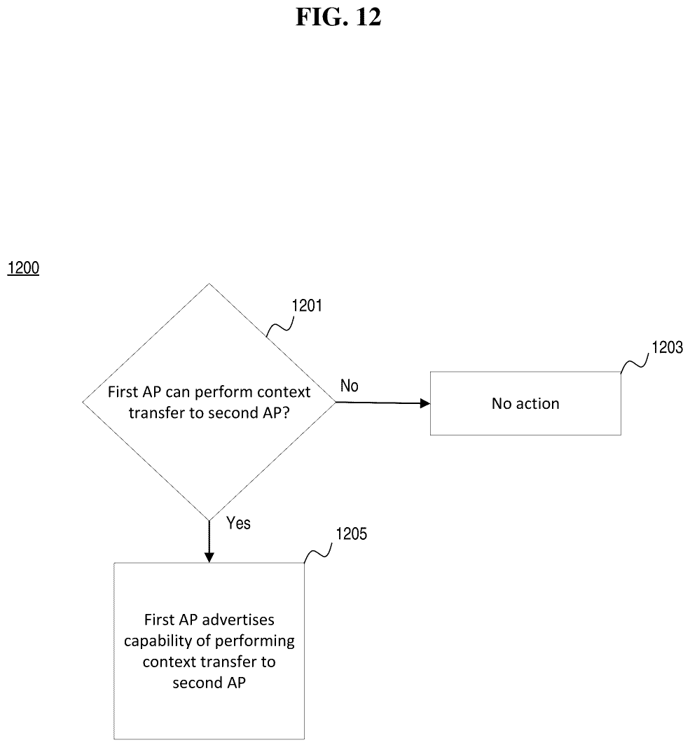

FIG. 12 illustrates a flow chart of an example process by an AP of performing a context transfer advertisement in accordance with an embodiment. Although one or more operations are described or shown in a particular sequential order, in other embodiments the operations may be rearranged in a different order, which may include performance of multiple operations in at least partially overlapping time periods. The flowchart depicted in FIG. 12 illustrates operations performed in an AP, such as the AP illustrated in FIG. 3.

The process 1200, in operation 1201, a first AP determines whether the first AP can perform a context transfer to a second AP. If the first AP determines that the first AP cannot perform the context transfer to the second AP, the process proceeds to operation 1203 and the first AP performs no action. If the first AP determines that the first AP can perform the context transfer to the second AP, the process proceeds to operation 1205.

In operation 1205, the first AP advertises a capability of performing a context transfer to a second AP.

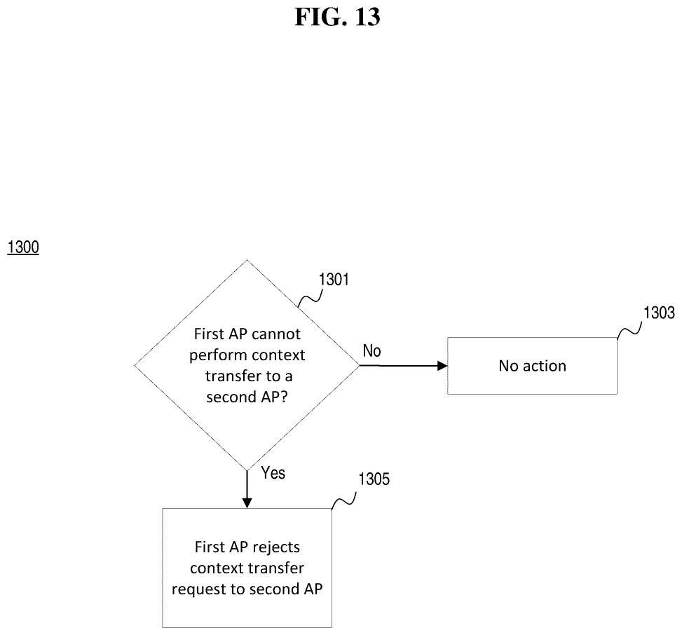

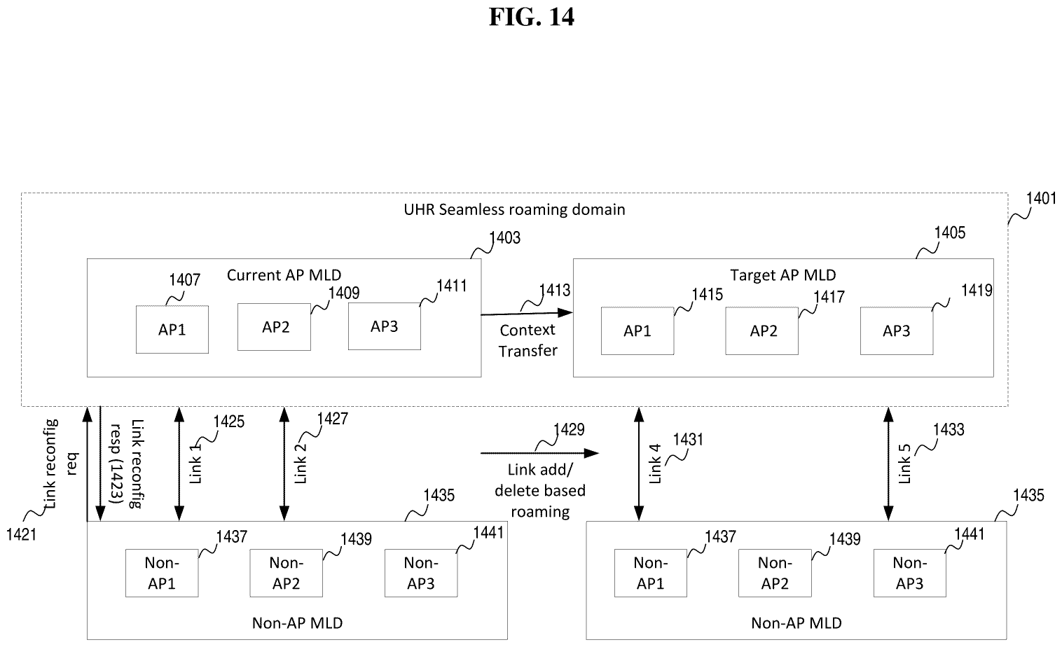

FIG. 13 illustrates a flow chart of an example process by an AP of rejecting a context transfer request in accordance with an embodiment. Although one or more operations are described or shown in a particular sequential order, in other embodiments the operations may be rearranged in a different order, which may include performance of multiple operations in at least partially overlapping time periods. The flowchart depicted in FIG. 14 illustrates operations performed in an AP, such as the AP illustrated in FIG. 3.

The process 1300, in operation 1301, a first AP determines whether the first AP cannot perform a context transfer to a second AP. If the first AP determines that the first AP can perform the context transfer to the second AP, the process proceeds to operation 1303 and the first AP performs no action. If the first AP determines that the first AP cannot perform the context transfer to the second AP, the process proceeds to operation 1305.

In operation 1305, the first AP rejects a context transfer request to the second AP.

In some embodiments, an AP may advertise information related to one or more neighbor APs and may include the additional information within one or more frames that the AP transmits (e.g., within a reduced neighbor report (RNR), neighbor report element, among others).

In some embodiments, when a STA performs roaming, an AP may implicitly determine to perform a context transfer request for the STA. In some embodiments, the STA may transmit a context transfer request message to the current AP or target AP to indicate to the current AP or target AP the one or more contexts that the STA intends to have transferred to the target AP from the current AP.

In some embodiments, a context transfer message may include one or more of the information items as shown in Table 2.

Table 2 provides information items that may be included in a context transfer request message in accordance with an embodiment.

TABLE 2

| Information items | Description |
|---|---|
| Contexts that can | One or more information items that can describe the |
| be transferred | contexts that can be transferred. e.g., a bitmap |
| | where each bit can refer to a particular context, |
| | individual fields for each context may be set to 1 |
| | or 0 values to make the indication, among others. |
| Transfer deadline | One or more information items that can describe |
| | a time deadline by which one or more contexts |
| | may be transferred. e.g., a time deadline |
| | relative to a current AP's time synchronization |
| | function (TSF) timer, number of target beacon |
| | transmission times (TBTTs) from the current |
| | TBTT, among others. |

In some embodiments, a current AP or target AP can transmit a response message that includes one or more of the information items as indicated in Table 3.

Table 3 provides one or more information items that may be included in a context transfer response message in accordance with an embodiment.

TABLE 3

| Information items | Description |
|---|---|
| Contexts that have | One or more information items that can describe one or more contexts |
| been transferred | that have been transferred. e.g., a bitmap where each bit can refer to a |
| | particular context, individual fields for each context may be set to 1 or |
| | 0 values to make the indication, among others. |
| Roam deadline | One or more information items that can describe a time deadline by |
| | which a STA needs to roam to a target AP. Otherwise, a target AP |
| | may not maintain the one or more contexts for the STA and the STA |
| | may need to re-setup the contexts with the target AP. |

In some embodiments, the STA may check which particular contexts have been transferred to a target AP. For the contexts that may not have been transferred, the STA may need to again setup those contexts with the target AP upon roaming to the target AP. In some embodiments, transmission of a context transfer response message be solicited (e.g., based on a request) or unsolicited by a STA.

In some embodiments, a link reconfiguration request frame may be used as a context transfer request message. A link reconfiguration request frame may be used by a non-AP MLD to setup links with a target AP MLD. In some embodiments, a link add request may be considered as an implicit indication that one or more contexts may need to be transferred from a current AP MLD to a target AP MLD that is indicated.

In some embodiments, a current AP MLD and a target AP MLD may be a part of a same seamless roaming domain (e.g., seamless mobility domain, non-collocated AP MLD, logical AP MLD, among others). When a non-AP MLD transmits a link reconfiguration request frame to a current AP MLD, the current AP MLD can initiate transfer of one or more near static contexts and/or one or more dynamic contexts from the current AP MLD to target AP MLD.

FIG. 14 illustrates an example of a context transfer in a seamless roaming domain in accordance with an embodiment. In particular, FIG. 14 illustrates a UHR seamless roaming domain 1401 that includes a current AP MLD 1403 and a target AP MLD 1405. The current AP MLD 1403 includes AP1 1407, AP2 1409, and AP3 1411. The target AP MLD includes AP1 1415, AP2 1417, and AP3 1419. There is also a non-AP MLD 1435 that includes non-AP1 1437, non-AP2 1439, and non-AP3 1441. Initially, the non-AP MLD 1435 is associated with the current AP MLD 1403 and has link 1 1425 established between non-AP1 1437 and AP1 1407, and link 2 1427 established between non-AP2 1439 and AP2 1409 of the current AP MLD 1403.

The non-AP MLD 1435 transmits to the UHR seamless roaming domain 1401, a link reconfiguration request message 1421. The link reconfiguration request message may indicate adding one or more links with the target AP MLD 1405. The link reconfiguration request message may also trigger a context transfer 1413 from the current AP MLD 1403 to the target AP MLD 1405. Accordingly, the UHR seamless roaming domain 1401 transmits to the non-AP MLD 1435, a link reconfiguration response message 1423.

Accordingly, after performing the link add/delete based roaming 1429 and the context transfer 1413, the non-AP MLD 1435 has added a link 4 1431 that is established between the non-AP1 1437 and AP1 1415 of the target AP MLD 1405. Also, link 5 1433 is added between non-AP3 1441 and AP3 1419 of the target AP MLD 1405. Accordingly, the links between the non-AP MLD 1435 and the current AP MLD 1403, including link 1 1425 and link 2 1427 were removed.

In some embodiments, a link reconfiguration request frame may have a format as shown in Table 4 in accordance with an embodiment.

Table 4 provides an example of one or more information items that may be included in a link reconfiguration request frame action field format in accordance with an embodiment.

TABLE 4

| Order | Meaning |
|---|---|
| 1 | Category |
| 2 | Protected ultra high reliability (UHR) or extremely |
| | high throughput (EHT) action |
| 3 | Dialog token |
| 4 | Near static context transfer indication or no roam |
| | indication |
| 5 | Target AP MLD identifier or Target AP MLD |
| | identifier list |
| 6 | Time Deadline |
| 7 | Context to be transferred |
| 8 | Reconfiguration Multi-link element |
| 9 | Oracle Cloud Infrastructure (OCI) element |

In some embodiments, a context transfer indication or a no roam indication may be included in a link reconfiguration request frame.

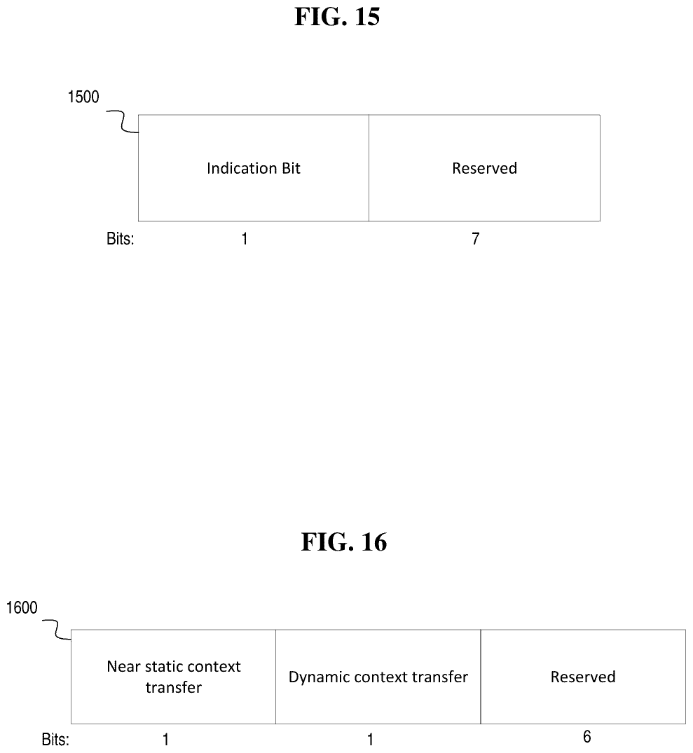

FIG. 15 illustrates a context transfer indication element that may be included in a link reconfiguration request frame in accordance with an embodiment. The context transfer indication element 1500 may include an indication bit field and a reserved field. The indication bit field may indicate whether or not a context transfer, including a static context transfer and/or a dynamic context transfer, needs to be performed. In some embodiments, if the indication bit field is set to a value of 0 and the frame is a first link reconfiguration request frame received by a current AP MLD from a non-AP MLD, then the frame may indicate to the current AP MLD that the current AP MLD may need to perform a link add with only a near static context transfer to a target AP MLD. In some embodiments, if the indication bit is set to a value of 1 and the frame is a first valid link reconfiguration request frame received by the current AP MLD from the non-AP MLD, then the frame may indicate to the current AP MLD that the current AP MLD may need to perform a link addition with a target AP MLD along with performing a near static and dynamic context transfer. In some embodiments, if the indication bit is set to a value of 1 and the frame is a second link reconfiguration request frame received by the current AP MLD from the non-AP MLD (the first frame was used for performing a near static context transfer), then the second frame may indicate that to the current AP MLD that the non-AP MLD may roam to the target AP MLD and the dynamic context transfer can be performed.

Table 5 provides an example of one or more information items that may be included in a multi-link reconfiguration framework usage using a single bit indication in accordance with an embodiment.

TABLE 5

| Bit | Reconfiguration | |
|---|---|---|
| value | ML element | Behavior |
| 0 | Present | Current AP MLD: |
| | | Can perform link add along with a near static context |
| | | transfer to the indicated target AP MLD in the request |
| | | frame. |
| | | Can generate and send a link reconfiguration response |
| | | frame to the non-AP MLD indicating a success or |
| | | failure. |
| | | Target AP MLD: |
| | | Can setup the links if possible. |
| | | Can accept the near static context transfer if possible. |
| | | Can inform the current AP MLD about the setup. |
| | | Non-AP MLD: |
| | | Can wait for the current AP MLD to send a response frame. |
| 1 | Present | Current AP MLD: |
| | | Can perform link add along with a near static context |
| | | transfer and a dynamic context transfer to the |
| | | indicated target AP MLD in the request frame. |
| | | Can generate and send a link reconfiguration response |
| | | frame to the non-AP MLD indicating a success or |
| | | failure. |
| | | Target AP MLD: |
| | | Can setup the links if possible. |
| | | Can accept the near static context if possible. |
| | | Can accept the dynamic context. |
| | | Can inform the current AP MLD about the setup. |
| | | Non-AP MLD: |
| | | Can wait for the current AP MLD to send a response |
| | | frame. |
| 1 | Absent | Current AP MLD: |
| | | Can prepare for the non-AP MLD to roam to the |
| | | target AP MLD. |
| | | Can perform a dynamic context transfer to the |
| | | indicated target AP MLD. |
| | | Can generate and transmit a response frame to the |
| | | non-AP MLD. |
| | | Target AP MLD: |
| | | Can accept the dynamic context transfer. |
| | | Can generate and transmit a response to the current |
| | | AP MLD. |
| | | Non-AP MLD: |
| | | Can wait for the current AP MLD to send a response. |

In some embodiments, a context transfer indication may include a one octet (e.g., 8 bits) field.

FIG. 16 illustrates a context transfer indication element in accordance with an embodiment. The element 1600 may include a near static context transfer bit field, a dynamic context transfer bit field, and a reserved field. In some embodiments, the near static context transfer field may provide an indication regarding whether a near static context needs to be performed. In some embodiments, the near static context transfer bit field may be 1 bit in size and provide a value that indicates a request to perform a near static context transfer. In some embodiments, a bit value of 1 in the near static context transfer field can indicate a need to perform a near static context transfer along with a link add operation. A bit value of 0 can indicate that near static context transfer does not need be performed.

The dynamic context transfer field may be 1 bit in size and provide a value that indicates a request to perform a dynamic context transfer. In some embodiments, a bit value of 1 in the dynamic context transfer indication bit filed can indicate a need to perform a roam with a dynamic context transfer. A bit value of 0 in the near static context transfer bit field with a value of 1 in the dynamic context transfer bit field can indicate a need to perform dynamic context transfer without near static context transfer. In some embodiments, a value of 0 in the near static context transfer bit with a value of 0 in the dynamic context transfer bit can indicate an invalid entry or may be reserved.

The reserved field may be 6 bits in size and may be reserved.

In some embodiments, when the near static context transfer indication is provided and a reconfiguration multi-link element is present with the reconfiguration operation type field set to a value to indicate add link, then the links can be added at the target AP MLD and a near static context transfer can be performed.

In some embodiments, when both near static and dynamic context transfer indications are provided and a reconfiguration multi-link element is present with the reconfiguration operation type field set to a value to indicate add link, then the links can be added at the target AP MLD and a near static context transfer and dynamic context transfer can be performed.

In some embodiments, when the context transfer indication is set to a value of 1 and a reconfiguration multi-link element is not present, then the target AP MLD may only perform a dynamic context transfer.

In some embodiments, when the context transfer indication is set to 0 and a reconfiguration multi-link element is not present, the current AP MLD can either drop or ignore the frame.

In some embodiments, an indication to perform context transfer only or preparation may be present in a reconfiguration operation type in a reconfiguration multi-link element. An example of a reconfiguration operation type field values in accordance with an embodiment is provided in Table 6.

Table 6 provides an example of one or more values for one or more operation types that may be provided in a reconfiguration operation type in accordance with an embodiment.

TABLE 6

| Value | Name |
|---|---|
| 0 | AP removal |
| 1 | Operation parameter update |
| 2 | Add link |
| 3 | Delete link |
| 4 | Non-simultaneous transceiver mode (NSTR) status update |
| 5 | Roam intent indication |
| 6 | Near static context transfer or preparation |
| 7-15 | Reserved |

In some embodiments, a reconfiguration operation type may be indicated via a reconfiguration operation type field by setting a value that indicates add link operation. In some embodiments, when a near static context transfer is indicated in the reconfiguration operation type field, an add link operation along with a near static context transfer can be performed. In some embodiments, a near static context transfer indication can be provided via an encoding.

In some embodiments, a target AP MLD identifier may be present in a link reconfiguration request frame.

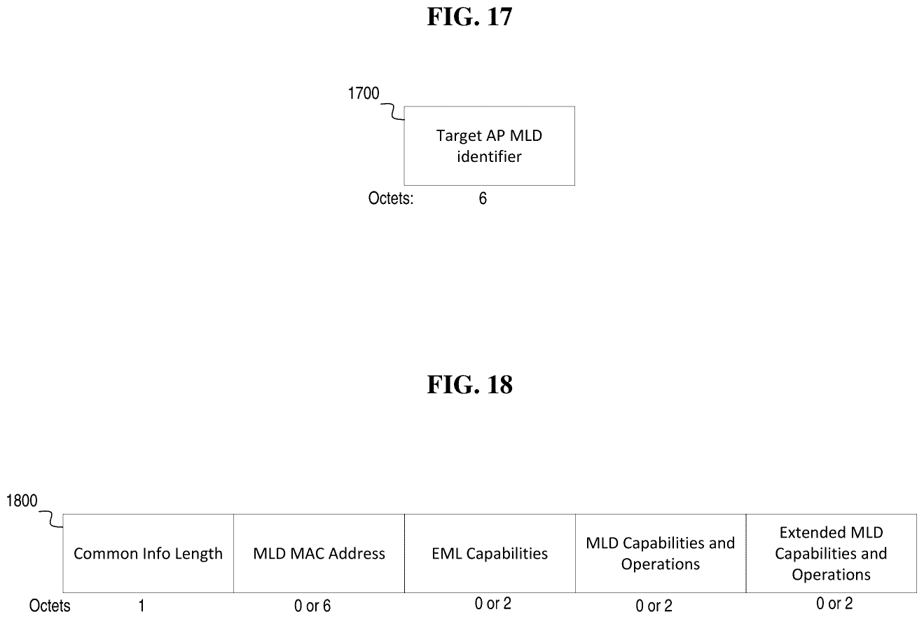

FIG. 17 illustrates an example format of target AP MLD identifier clement of a link reconfiguration request frame in accordance with an embodiment. In particular, the target AP MLD identifier element 1700 may be 6 octets in size (e.g., 48 bits) and may provide a list of one or more target AP MLD identifiers fields. In some embodiments, there may be only one target AP MLD identifier field and that identifier can also be indicated in a MLD MAC address of a common info field of the reconfiguration multi-link element.

FIG. 18 illustrates an example of a target AP MLD identifier in a common info field of a reconfiguration multi-link element in accordance with an embodiment. The element 1800 may include a common info length field, an MLD MAC address field, an EML capabilities field, an MLD capabilities and operations field, and an extended MLD capabilities and operations field.

The common info length field may provide length information of the element 1800. The MLD MAC address field may provide a target AP MLD identifier and may be 0 or 6 octets in size based on whether the field is present. The EML capabilities field may be 0 or 2 octets in size based on whether the field is present and may provide EML capabilities information. The MLD capabilities and operations field may be 0 or 2 octets in size based on whether the field is present and may provide MLD capabilities and operations information. The extended MLD capabilities and operations field may be 0 or 2 octets in size based on whether the field is present and may provide extended MLD capabilities and operations information.

In some embodiments, there may be one target AP MLD identifier which may be indicated in a new field added to a common info field of a reconfiguration multi-link element.

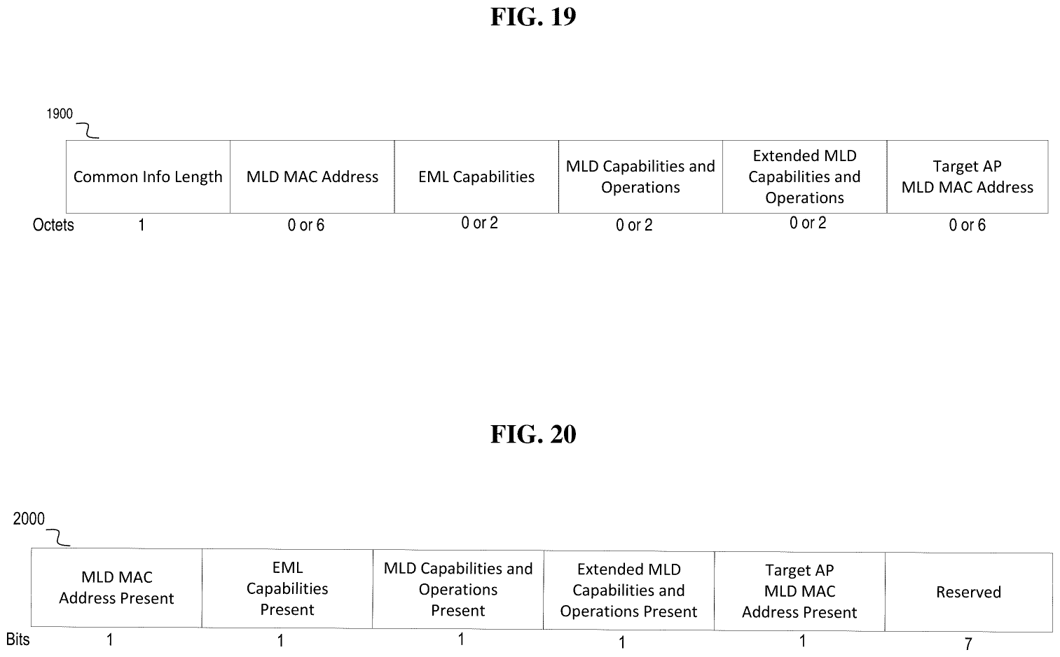

FIG. 19 illustrates an example of a target AP MLD identifier in a common info field of a reconfiguration multi-link clement in accordance with an embodiment. The clement 1900 may include a common info length field, an MLD MAC address field, an EML capabilities field, an MLD capabilities and operations field, an extended MLD capabilities and operations field, and a target AP MLD MAC address field.

The common info length field may provide length information of the element 1900. The MLD MAC address field may provide an MLD MAC address and may be 0 or 6 octets in size based on whether the field is present. The EML capabilities field may be 0 or 2 octets in size based on whether the field is present and may provide EML capabilities information. The MLD capabilities and operations field may be 0 or 2 octets in size based on whether the field is present and may provide MLD capabilities and operations information. The extended MLD capabilities and operations field may be 0 or 2 octets in size based on whether the field is present and may provide extended MLD capabilities and operations information. The target AP MLD MAC address field may be 0 or 6 octets in size based on whether the field is present and may provide a target AP MLD MAC address.

In some embodiments, a presence bitmap may carry a bit to indicate a presence of a target AP MLD MAC address in a common info field of a reconfiguration multi-link element.

FIG. 20 illustrates an example of a presence indication bit for a target AP MLD MAC address in a common info field of a reconfiguration multi-link element in accordance with an embodiment. The element may include a MLD MAC Address present field, an EML capabilities present field, an MLD capabilities and operations present field, an extended MLD capabilities and operations present field, a target AP MLD MAC address present field and a reserved field.

The MLD MAC Address present bit can be set to 1 if the MLD MAC address is present in the common info field, otherwise, the bit can be set to 0.

The EML capabilities present bit can be set to 1 if the EML capabilities is present in the common info field, otherwise, the bit can be set to 0.

The MLD capabilities and operations present bit can be set to 1 if the MLD capabilities and operations is present in the common info field, otherwise, the bit can be set to 0.

The extended MLD capabilities and operations present bit can be set to 1 if the extended MLD capabilities and operations is present in the common info field, otherwise, the bit can be set to 0.

The target AP MLD MAC Address present bit can be set to 1 if the target AP MLD MAC address is present in the common info field, otherwise, the bit can be set to 0.

The reserved field may be reserved.

In some embodiments, the link reconfiguration request frame may include an indication of a time deadline before which the non-AP MLD wants the links to be added at the target AP MLD. In some embodiments, a deadline may be referred to as a timeout.

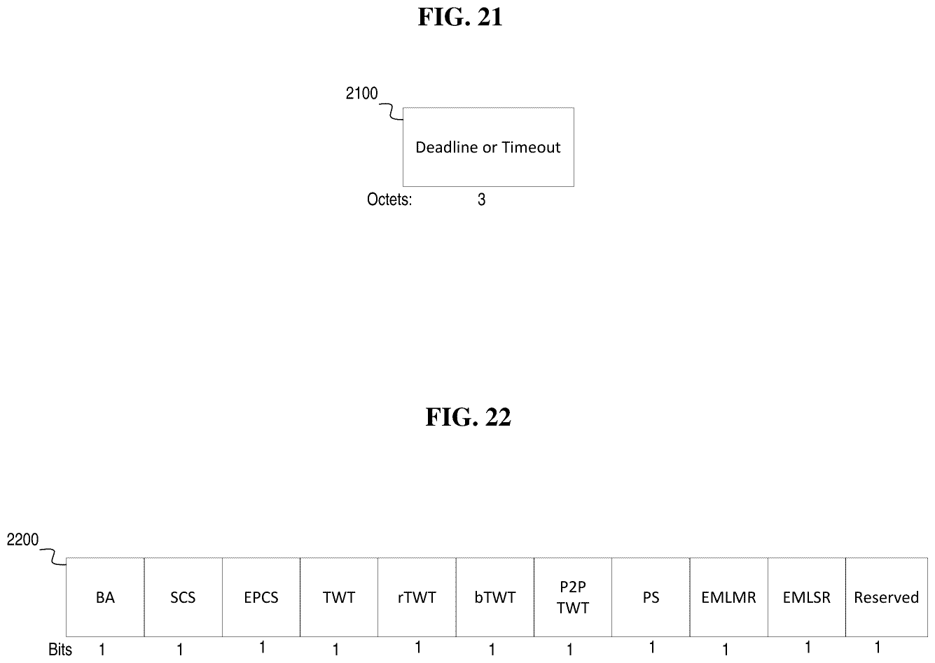

FIG. 21 illustrates an example format of a deadline or timeout clement in accordance with an embodiment. The deadline or timeout element 2100 may be 3 octets in size and may provide information of a time deadline before which a non-AP MLD wants one or more links to be added at a target AP MLD.

In some embodiments, a reconfiguration multi-link element can include per-STA profile for each requested link at the target AP MLD. In some embodiments, the link ID field can indicate the link at the target AP MLD for which the link add operation has been requested.

In some embodiments, there can be an indication of context to be transferred. This indication can enable a non-AP MLD to provide an indication to the current AP MLD about the context that can be transferred to the target AP MLD. In some embodiments, there can be a bit corresponding to each context to be transferred to the target AP MLD.

FIG. 22 illustrates an example of a context transfer indication element in accordance with an embodiment. Accordingly, the element 2200 may include one or more fields for one or more contexts, including a BA field, a SCS field, an EPCS field, a TWT field, a rTWT field, a bTWT field, a P2P TWT field, a PS field, a EMLMR field, an EMLSR field, and a reserved field. In some embodiments, a value of 1 in the bit position corresponding to a respective context can indicate to the current AP MLD that the corresponding context can be transferred to the target AP MLD. A value of 0 in the bit position corresponding to a respective context can indicate to the current AP MLD that the corresponding context cannot be transferred to the target AP MLD.

In some embodiments, signaling can be achieved via an extremely high throughput (EHT) variant link reconfiguration request frame. In some embodiments, the signaling information can be included inside a reconfiguration multi-link (ML) element. For example, a target AP MLD identifier may be included in a common info field. In some embodiments, there can be an indication of context transfer presence in the presence bitmap. In some embodiments, the remaining information items can either be added to the common info field with an indication of their presence in the presence bitmap. In some embodiments, the remaining information can be added to an SMD roaming element which can be added to the request frame as shown in the table 7.

Table 7 provides an example of one or more information items that may be included in an extremely high throughput (EHT) variant link reconfiguration request frame action field format in accordance with an embodiment.

TABLE 7

| x | Meaning |
|---|---|
| 1 | Category |
| 2 | Protected EHT Action |
| 3 | Dialog token |
| 4 | Reconfiguration Multi-link element (carries an indication |
| | of the target AP MLD in common info) |
| 5 | OCI element |
| 6 | SMD roaming element (includes: near static context |
| | transfer indication or no roam indication, deadline, |
| | context to be transferred, among others) |

Table 8 provides an example of one or more information items that may be included in an EHT variant link reconfiguration request frame action field format in accordance with an embodiment.

TABLE 8

| Order | Meaning |
|---|---|
| 1 | Category |
| 2 | Protected EHT Action |
| 3 | Dialog token |
| 4 | Reconfiguration Multi-link element (carries an indication |
| | of the target AP MLD in common info, near static context |
| | transfer indication or no roam indication, deadline, context |
| | to be transferred, among others) |
| 5 | OCI element |

In some embodiments, when an add link operation is indicated and the target AP MLD identifier is not the same as the current AP MLD identifier, the current AP MLD can infer that links can be set at the target AP MLD and context transfer can be performed.

In some embodiments, when a roam intent indication is indicated via the corresponding value in the reconfiguration operation type field and a prior preparation phase is not complete (e.g., links are not added and near static context transfer is not performed), the current AP MLD can help to add links at the target AP MLD and perform near static and/or dynamic context transfer. In some embodiments, if the roam intent indication is indicated via the corresponding value in the reconfiguration operation type field and a prior preparation phase is complete but the links indicated are not the same as the ones in the preparation phase, then the current AP MLD can perform a new link setup with the indicated target AP MLD and perform near static context transfer and/or dynamic context transfer.

In some embodiments, if the target AP MLD indicated in the preparation phase and the target AP MLD indicated in the roam phase are different, the current AP MLD can help to add the links at the new target AP MLD indicated in the roam phase along with near static context transfer and/or dynamic context transfer to the new target AP MLD.

Table 9 provides a format of a link reconfiguration response frame in accordance with an embodiment.

TABLE 9

| Order | Meaning |
|---|---|
| 1 | Category |
| 2 | Protected EHT/UHR Action |
| 3 | Dialog Token |
| 4 | Deadline |
| 5 | AID |
| 6 | Count |
| 7 | Reconfiguration Status List |
| 8 | Group Key Data (optional) |
| 9 | OCI element (optional) |
| 10 | Basic Multi-link element (optional) |

In some embodiments, a deadline value in the link reconfiguration response frame can indicate a deadline before which the roam execution phase may need to be initiated. In some embodiments, if the non-AP MLD does not initiate a roam execution phase prior to the deadline, then links can be deleted at the target AP MLD or the addition of links may not hold true. In such a case, the non-AP MLD can re-setup one or more of the links by doing an association with the target AP MLD if the non-AP MLD choses to roam to the target AP MLD. The non-AP MLD can also perform another preparation phase with the current AP MLD. A format of a deadline or timeout field is illustrated in FIG. 21 in accordance with an embodiment.

In some embodiments, a deadline or timeout may be present in an element which may be advertised by an AP MLD in management frames (e.g., probe response, (re) association response, beacon, among others). The deadline or timeout value advertised by an AP MLD in a SMD may apply to one or more of the AP MLDs (e.g., apply to all the AP MLDs) in the same SMD as the advertising AP MLD.

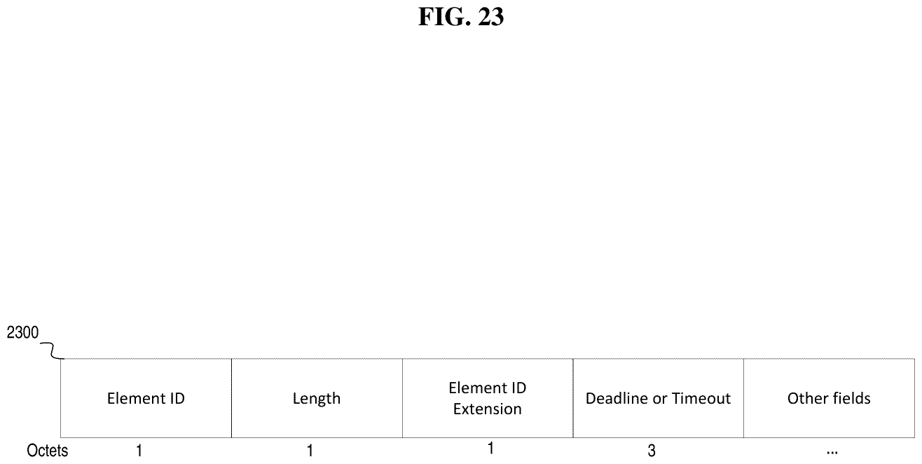

FIG. 23 illustrates an example format of an SMD information element in accordance with an embodiment. The element 2300 may include an element ID field, a length field, an element ID extension field, a deadline or timeout field, and other fields.

The element ID field and the element ID extension field may provide element identification information for the element 2300. The length field may provide length information for the element 2300.

The deadline or timeout field may be set to a value equal to a maximum value that can be experienced between a preparation phase and a roaming phase. If the non-AP MLD does not perform a roaming within this timeout value, the preparation performed during the preparation phase (e.g., links added, static and/or dynamic contexts transferred, among others) may be invalid. If the non-AP MLD performs a roaming within the timeout value, then the preparation performed may remain valid.

In some embodiments, a deadline or timeout value may be advertised by a current AP MLD as a default timeout value and the current AP MLD may provide another timeout value in a request frame if the advertised timeout value is no longer valid.

In some embodiments, an association identifier (AID) may be an AID value that can be used at a target AP MLD.

In some embodiments, if the target AP MLD is prepared, then a success indication can be provided (e.g., via the reconfiguration ML element, among others). If the target AP MLD is not prepared, then a failure indication can be provided. In some embodiments, the failure indication can be provided via a status indication in a reconfiguration duple.

In some embodiments, an EHT variant link reconfiguration request frame can be included either inside a basic ML element or inside an SMD roaming element.

Table 10 provides an example of an EHT variant link reconfiguration response frame action field format in accordance with an embodiment.

TABLE 10

| Order | Meaning |
|---|---|
| 1 | Category |
| 2 | Protected EHT/UHR Action |
| 3 | Dialog Token |
| 6 | Count |
| 7 | Reconfiguration Status List |
| 8 | Group Key Data (optional) |
| 9 | OCI element (optional) |
| 10 | Basic Multi-link element (optional): includes deadline, AID |

Table 11 provides an example of an EHT variant link reconfiguration response frame action field format in accordance with an embodiment.

TABLE 11

| Order | Meaning |
|---|---|
| 1 | Category |
| 2 | Protected EHT/UHR Action |
| 3 | Dialog Token |
| 6 | Count |
| 7 | Reconfiguration Status List |
| 8 | Group Key Data (optional) |
| 9 | OCI element (optional) |
| 10 | Basic Multi-link element (optional) |
| 11 | SMD roaming element: deadline, AID |

In some embodiments, a group key data may not be provided during the preparation phase in a link reconfiguration response frame and thus may be missing in the response frame.

In some embodiments, when a non-AP MLD transmits a link reconfiguration request frame to the non-AP MLD's current AP MLD and the link reconfiguration requests the current AP MLD to perform a link add operation with a target AP MLD that is a part of the same seamless roaming mobility domain as the current AP MLD, the current AP MLD can perform a link add operation for the indicated link with the target AP MLD and perform a near static context transfer to the target AP MLD.

In some embodiments, if there is no indication of an intent to roam or there is an indication that a link add with near static context is requested, the current AP MLD can perform necessary procedures to prepare the indicated links in the reconfiguration multi-link element at the target AP MLD. When a link add is performed at the target AP MLD, the link reconfiguration response frame may include other information items such as group key data, OCI element, basic multi-link element, among other information items.

In some embodiments, if there is an indication of an intent to roam and a preparation phase has already been completed, the current AP MLD can perform a dynamic context transfer.

In some embodiments, the current AP MLD may perform a dynamic context transfer if there is no explicit indication of a request for a near static context transfer.

In some embodiments, if there is an indication of an intent to roam and a preparation phase has not been completed, the current AP MLD can perform both a link add operation at the target AP MLD along with context transfer of both near static and dynamic contexts. In some embodiments, the current AP MLD may perform both a link add operation at the target AP MLD along with context transfer of both near static and dynamic contexts if there is an explicit indication of a near static context transfer along with an explicit indication for a dynamic context transfer.

Examples of near static context transfers may include SCS, MSCS, EPCS, among others. In SCS, information from SCS descriptor elements of SCS streams established between a non-AP MLD and the current AP MLD may be transferred to a target AP MLD.

In MSCS, a tuple of information from MSCS descriptor element of established MSCS and the corresponding UP with the current AP MLD may be transferred to a target AP MLD.

In EPCS, EPCS authorization and state of a non-AP MLD at the current AP MLD may be transferred to a target AP MLD.

Embodiments in accordance with this disclosure provide roaming procedures whereby a STA may transmit an intent to roam to one or more neighboring APs to a current AP associated with the STA. In some embodiments, a context transfer may be performed to transfer contexts from a current AP to a target AP, where the context transfer may reduce a time that may be needed for a link to reach an optimal performance level upon the STA roaming to a target AP. A context transfer may include an exchange of relevant information between APs, including between a current AP and a target AP, such that the target AP is aware of one or more parameters of one or more contexts when the STA roams to the target AP. Accordingly, a STA may seamlessly roam to different APs without having to re-setup one or more contexts, providing optimized link performance, reduced latency, and improved wireless communications.

A reference to an element in the singular is not intended to mean one and only one unless specifically so stated, but rather one or more. For example, “a” module may refer to one or more modules. An element proceeded by “a,” “an,” “the,” or “said” does not, without further constraints, preclude the existence of additional same elements.

Headings and subheadings, if any, are used for convenience only and do not limit the inventive subject matter. The word exemplary is used to mean serving as an example or illustration.

To the extent that the term “include,” “have,” or the like is used, such term is intended to be inclusive in a manner similar to the term “comprise” as “comprise” is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A phrase “at least one of” preceding a series of items, with the terms “and” or “or” to separate any of the items, modifies the list as a whole, rather than each member of the list. The phrase “at least one of” does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

It is understood that the specific order or hierarchy of steps, operations, or processes disclosed is an illustration of exemplary approaches. Unless explicitly stated otherwise, it is understood that the specific order or hierarchy of steps, operations, or processes may be performed in different order. Some of the steps, operations, or processes may be performed simultaneously or may be performed as a part of one or more other steps, operations, or processes. The accompanying method claims, if any, present elements of the various steps, operations or processes in a sample order, and are not meant to be limited to the specific order or hierarchy presented.

These may be performed in serial, linearly, in parallel or in different order. It should be understood that the described instructions, operations, and systems can generally be integrated together in a single software/hardware product or packaged into multiple software/hardware products.

The disclosure is provided to enable any person skilled in the art to practice the various aspects described herein. In some instances, well-known structures and components are shown in block diagram form in order to avoid obscuring the concepts of the subject technology. The disclosure provides various examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using a phrase means for or, in the case of a method claim, the element is recited using the phrase step for.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. This method of disclosure is not to be interpreted as reflecting an intention that the claimed subject matter requires more features than are expressly recited in each claim. Rather, as the following claims reflect, inventive subject matter lies in less than all features of a single disclosed configuration or operation. The following claims are hereby incorporated into the detailed description, with each claim standing on its own as a separately claimed subject matter.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

What is claimed is:

1. A non-access point (AP) multi-link device (MLD) in a wireless network, the non-AP MLD comprising:
one or more stations (STAs) affiliated with the non-AP MLD; and
a processor coupled to the one or more STAs, the processor configured to:
transmit, to an AP MLD currently associated with the non-AP MLD, a first request frame including a preparation request for roaming from the AP MLD to a target AP MLD, the preparation request including (i) a medium access control (MAC) address for the target AP MLD and (ii) per-STA profile for each affiliated STA that the non-AP MLD requests; and
receive, from the AP MLD, a first response frame indicating that the requested preparation is successful, the first response frame including an association identifier (AID) that is assigned to the non-AP MLD by the target AP MLD.

2. The non-AP MLD of claim 1, wherein the first request frame includes information indicating whether the non-AP MLD requests one or more contexts not to be transferred from the AP MLD to the target AP MLD.

3. The non-AP MLD of claim 1, wherein one or more contexts established between the non-AP MLD and the AP MLD are transferred from the AP MLD to the target AP MLD.

4. The non-AP MLD of claim 1, wherein stream classification service (SCS) descriptors of one or more SCS established with the AP MLD are transferred from the AP MLD to the target AP MLD.

5. The non-AP MLD of claim 1, wherein mirrored stream classification service (MSCS) descriptor of an MSCS established with the AP MLD are transferred from the AP MLD to the target AP MLD.

6. The non-AP MLD of claim 1, wherein the processor is further configured to:
receive, from the AP MLD, a frame that includes a time deadline indicating a time value between the first response frame indicating that the requested preparation is successful and an execution phase by which the non-AP MLD is to transition from the AP MLD to the target AP MLD.

7. The non-AP MLD of claim 6, wherein the processor is further configured to:
transmit, to the AP MLD within the time deadline, a second request frame including an execution request to transition to the target AP MLD.

8. The non-AP MLD of claim 1, wherein the first request frame includes information indicating whether the MAC address for target AP MLD is present.

9. The non-AP MLD of claim 1, wherein the first frame includes a field that includes a first value to indicate the preparation request.

10. The non-AP MLD of claim 1, wherein the AP MLD and the target AP MLD are part of a same seamless mobility domain (SMD).

11. An access point (AP) multi-link device (MLD) in a wireless network, the AP MLD comprising:
one or more APs affiliated with the AP MLD; and
a processor coupled to the one or more APs, the processor configured to:
receive, from a non-AP MLD currently associated with the AP MLD, a first request frame including a preparation request for roaming from the AP MLD to a target AP MLD, the preparation request including (i) a medium access control (MAC) address for the target AP MLD and (ii) per-station (STA) profile for each affiliated STA that the non-AP MLD requests; and
transmit, to the non-AP MLD, a first response frame indicating that the requested preparation is successful, the first response frame including an association identifier (AID) that is assigned to the non-AP MLD by the target AP MLD.

12. The AP MLD of claim 11, wherein the first request frame includes information indicating whether the non-AP MLD requests one or more contexts not to be transferred from the AP MLD to the target AP MLD.

13. The AP MLD of claim 11, wherein the processor is further configured to transfer one or more contexts established between the non-AP MLD and the AP MLD from the AP MLD to the target AP MLD.

14. The AP MLD of claim 11, wherein the processor is further configured to transfer stream classification service (SCS) descriptors of one or more SCS established with the non-AP MLD from the AP MLD to the target AP MLD.

15. The AP MLD of claim 11, wherein the processor is further configured to transfer mirrored stream classification service (MSCS) descriptor of an MSCS established with the non-AP MLD from the AP MLD to the target AP MLD.

16. The AP MLD of claim 11, wherein the processor is further configured to:
transmit, to the non-AP MLD, a frame that includes a time deadline indicating a time value between the first response frame indicating that the requested preparation is successful and an execution phase by which the non-AP MLD is to transition from the AP MLD to the target AP MLD.

17. The AP MLD of claim 16, wherein the processor is further configured to:
receive, from the non-AP MLD within the time deadline, a second request frame including an execution request to transition to the target AP MLD.

18. The AP MLD of claim 11, wherein the first request frame includes information indicating whether the MAC address for target AP MLD is present.

19. The AP MLD of claim 11, wherein the first frame includes a field that includes a first value to indicate the preparation request.

20. The AP MLD of claim 11, wherein the AP MLD and the target AP MLD are part of a same seamless mobility domain (SMD).
